(19) United States
(12) Patent Application Publication
(10) Pub. No.: US 2017/0353570 A1
(43) Pub. Date: Dec. 7, 2017

(54) INFORMATION PROCESSING DEVICE, INFORMATION PROCESSING METHOD, AND PROGRAM

(71) Applicant: SONY CORPORATION, TOKYO (JP)

(72) Inventors: MASATOSHI HAYASHI, KANAGAWA (JP); TOMOHISA NARA, TOKYO (JP); SHIGERU INOUE, TOKYO (JP); KOJI OHATA, TOKYO (JP)

(73) Assignee: SONY CORPORATION, TOKYO (JP)

(21) Appl. No.: 15/540,069

(22) PCT Filed: Jan. 8, 2016
(86) PCT No.: PCT/JP2016/050460

§ 371 Date: Jun. 27, 2017

(30) Foreign Application Priority Data
Jan. 14, 2015 (JP) 2015-004704

(51) Int. Cl. H04L 29/08

(52) U.S. Cl. CPC H04L 67/26; H04L 67/303; H04L 67/104; H04L 67/125; H04L 67/22

(57) ABSTRACT

[Object] To enable devices to notify of information in a preferred mode depending on a situation in which the plurality of devices operating in cooperation with one another are used. [Solution] Provided is an information processing device including: a control unit configured to select a device caused to perform information notification from a plurality of devices each including a notification unit and cooperating via a network on the basis of information regarding the devices; and an acquisition unit configured to acquire information regarding a user. The control unit selects the device caused to perform the information notification on the basis of the acquired information regarding the user.

### TECHNICAL FIELD

The present disclosure relates to an information processing device, an information processing method, and a program.

### BACKGROUND ART

With widespread communication technologies based on standards such Bluetooth (registered trademark) and wireless fidelity (Wi-Fi) (registered trademark), systems operating in cooperation with a plurality of devices via a network have been proposed.

Also, in recent years, cooperation target devices have not been limited to so-called smartphones and tablet terminals. For example, so-called wearable devices such as wristwatch type or glasses type information processing devices worn on parts of the bodies of users to be used have become widespread.

### CITATION LIST

### Patent Literature

Patent Literature 1: JP 2003-174399 A

### DISCLOSURE OF INVENTION

### Technical Problem

On the other hand, in systems operating in cooperation with a plurality of devices, users are notified of the same information individually from the plurality of devices. In such situations, if a user is notified of the information by one of the devices, it is not necessary for other devices to notify of the information in some cases. The user may feel annoyed in some cases when the plurality of devices notify the individual user of the information.

In view of such situations, Patent Literature 1 discloses an example of a technology for setting priority in advance in devices connected via a network, selecting several devices according to the priority, and notifying only the selected devices of information.

However, in recent years, with various widespread devices such as wearable devices, situations in which systems in which the devices cooperate are used (for example, systems or user states or environments in which the systems are used) have diversified, and thus preferred modes for notifying users of information also differ depending on the states or environments.

Accordingly, the present disclosure proposes an information processing device, an information processing method, and a program capable of enabling devices to notify of information in a preferred mode depending on a situation in which the plurality of devices operating in cooperation with one another are used.

### Solution to Problem

According to the present disclosure, there is provided an information processing device including: a control unit configured to select a device caused to perform information notification from a plurality of devices each including a notification unit and cooperating via a network on the basis of information regarding the devices; and an acquisition unit configured to acquire information regarding a user. The control unit selects the device caused to perform the information notification on the basis of the acquired information regarding the user.

Further, according to the present disclosure, there is provided an information processing method including: selecting, by a processor, a device caused to perform information notification from a plurality of devices each including a notification unit and cooperating via a network on the basis of information regarding the devices; and acquiring information regarding a user. The device caused to perform the information notification is selected on the basis of the acquired information regarding the user.

Further, according to the present disclosure, there is provided a program causing a computer to perform: selecting a device caused to perform information notification from a plurality of devices each including a notification unit and cooperating via a network on the basis of information regarding the devices; and acquiring information regarding a user. The device caused to perform the information notification is selected on the basis of the acquired information regarding the user.

### Advantageous Effects of Invention

According to the present disclosure described above, it is possible to provide an information processing device, an information processing method, and a program capable of enabling a plurality of devices to notify of information in a preferred mode depending on a situation in which the devices operate in cooperation with one another.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an example of a schematic configuration of an information processing system according to an embodiment of the present disclosure.

FIG. 2 is an explanatory diagram illustrating examples of schematic operations of information processing devices which form a cooperation network.

FIG. 3 is an explanatory diagram illustrating examples of schematic operations of information processing devices which form a cooperation network.

FIG. 4 is a block diagram illustrating examples of functional configurations of the information processing devices which form the cooperation network according to the embodiment.

FIG. 5 is a diagram illustrating an example of a profile table.

FIG. 6 is a diagram illustrating examples of attributes set in the information processing devices and setting of priority between the attributes.

FIG. 7 is an explanatory diagram illustrating an operation of a cooperation processing unit related to setting for information notification.

FIG. 8 is an explanatory diagram illustrating an operation of a cooperation processing unit related to setting for information notification.

FIG. 9 is a diagram illustrating an example of a correspondent relation between states corresponding to exception conditions and exception processes performed in accordance with the states.

FIG. 10 is a flowchart illustrating an example of the flow of a series of operations of the information processing device according to the embodiment.

FIG. 11 is a flowchart illustrating an example of the flow of a series of operations of the information processing device according to the embodiment.

FIG. 12 is an explanatory diagram illustrating an example of control of the cooperation network according to Example 1.

FIG. 13 is an explanatory diagram illustrating an example of control of the cooperation network according to Example 1.

FIG. 14 is an explanatory diagram illustrating an example of control of the cooperation network according to Example 2.

FIG. 15 is an explanatory diagram illustrating an example of control of the cooperation network according to Example 3.

FIG. 16 is an explanatory diagram illustrating an example of control of the cooperation network according to Example 4.

FIG. 17 is an explanatory diagram illustrating an example of control of the cooperation network according to Example 5.

FIG. 18 is a diagram illustrating an example of the hardware configuration of the information processing device 10 according to the embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

In addition, the description will be made in the following order.
1. Overview
2. Functional configuration
3. Processes
3.1. When operated as hardware master
3.2. When operated as software master
4. Examples
4.1. Example 1: control example when software master withdraws
4.2. Example 2: control example when image is photographed
4.3. Example 3: control example when user is moving by train
4.4. Example 4: control example related to allocation of functions involved in detection of information
4.5. Example 5: control example related to allocation of functions involved in image photographing
5. Hardware configuration
6. Conclusion

### 1. OVERVIEW

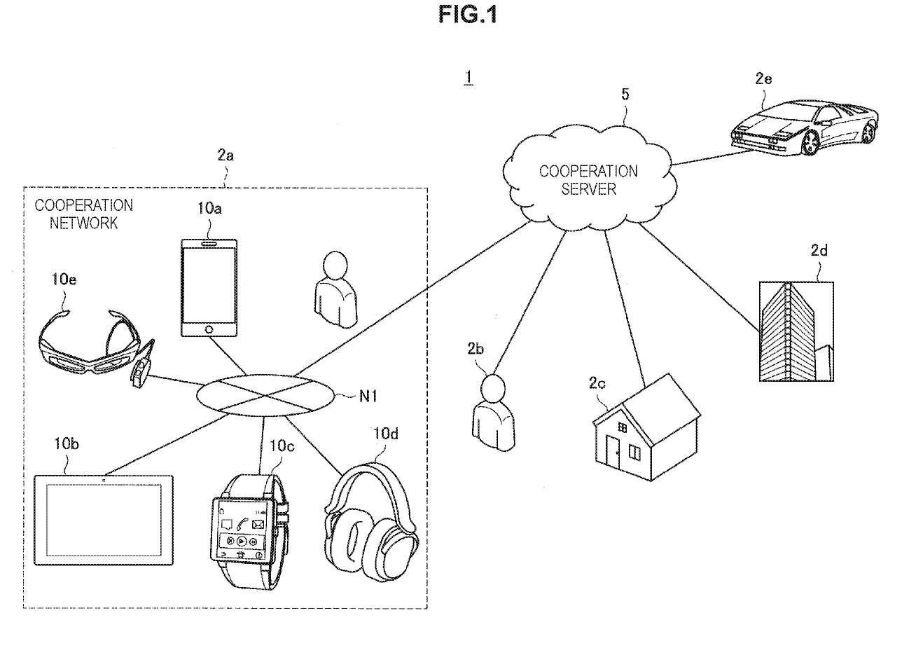

First, a schematic configuration of an information processing system according to an embodiment of the present disclosure will be described with reference to FIG. 1. FIG. 1 is an explanatory diagram illustrating an example of the schematic configuration of an information processing system 1 according to the embodiment.

As illustrated in FIG. 1, the information processing system according to the embodiment includes a cooperation server 5 and cooperation networks 2 in which a plurality of information processing devices 10 operate in cooperation with one another. For example, in the example illustrated in FIG. 1, cooperation networks 2a to 2e are configured to be able to communicate with the cooperation server 5. Also, the cooperation network 2a is configured such that information processing devices 10a to 10e connected via a network N1 can operate in cooperation with one another.

In addition, the information processing devices 10 included in the cooperation network 2 are not limited to information processing devices such as so-called smartphones and tablet terminals. For example, so-called wearable devices such as wristwatch type or glasses type information processing devices worn on parts of the bodies of users to be used can also be included.

For example, in the example illustrated in FIG. 1, the cooperation network 2a is configured such that the information processing devices 10a to 10e are connected via the network N1. The information processing device 10a is an example of the information processing device 10 configured as a smartphone. Also, the information processing device 10 b is an example of the information processing device 10 configured as a tablet terminal. Also, the information processing devices 10c to 10e are examples of the information processing devices 10 configured as wearable devices. Examples of the wearable devices include a watch (the information processing device 10c), a headset (the information processing device 10d), and a glasses type terminal (the information processing device 10e).

Of course, the information processing devices 10a to 10 e are merely examples and the types of information processing devices 10 are not limited as long as the information processing devices 10 are devices which can operate in cooperation with one another via a network. As a specific example, the information processing devices 10 may be electric devices in homes, equipment in homes, devices in automobiles, or devices installed in public spaces.

Also, as long as the information processing devices 10a to 10e can operate in cooperation with one another (for example, can transmit and receive various kinds of information one another), the type of network N1 is not particularly limited. As a specific example, the network N1 may be configured as a wired or wireless network. Examples of the wireless network include networks based on communication standards such as Bluetooth (registered trademark) and wireless fidelity (Wi-Fi) (registered trademark). Also, the network N1 may include a plurality of networks or may include both a wireless network and a wired network. Also, the network N1 may be a so-called home network (for example, the cooperation network 2c), a so-called corporate network (for example, the cooperation network 2d), or a so-called in-vehicle network (for example, the cooperation network 2e), or the like.

Also, the cooperation server 5 is configured to manage information regarding the various information processing devices 10 which form the cooperation networks 2. Examples of the information regarding the information processing devices 10 managed by the cooperation server 5 include information regarding functions of the information processing devices 10 and performance information regarding the functions. In addition, hereinafter, information regarding functions of the information processing devices 10, such as information of the information processing devices 10 or performance information regarding the functions is referred to as “device information” in some cases.

In addition, at least some information processing devices 10 among the plurality of information processing devices 10 which form the cooperation networks 2 may be configured to be able to communicate with the cooperation server 5. In such a configuration, for example, the information processing devices 10 which can communicate with the cooperation server 5 can also acquire information regarding other cooperation target information processing devices 10 from the cooperation server 5. Of course, each of the plurality of information processing devices 10 which form the cooperation networks 2 may not necessarily be configured to be able to communicate with the cooperation server 5.

An example of the schematic configuration of the information processing system 1 according to the embodiment has been described above with reference to FIG. 1.

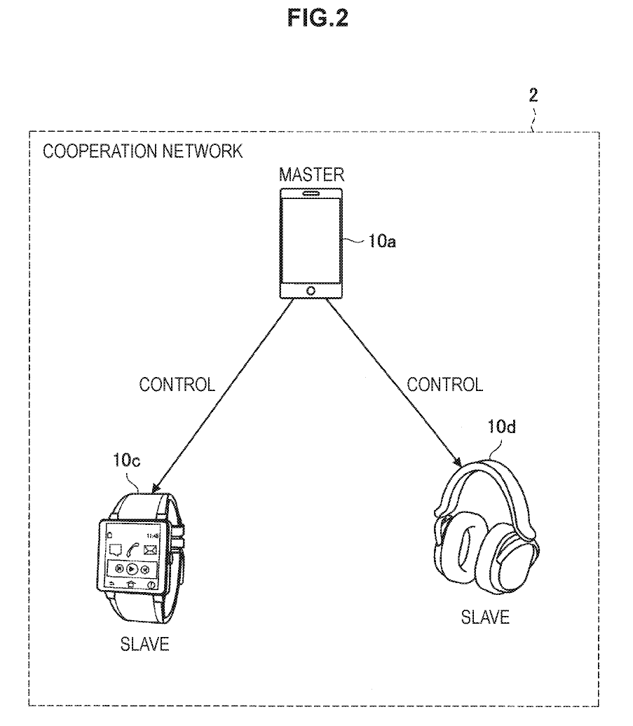

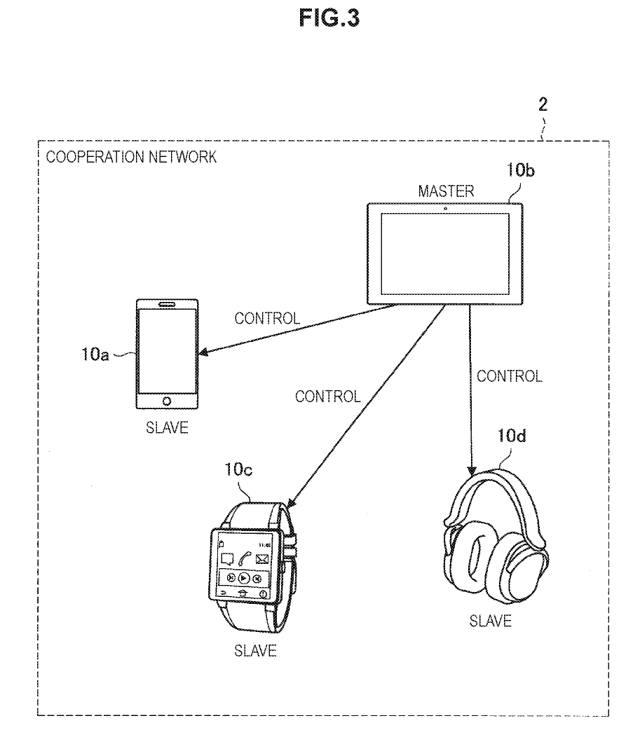

Next, examples of schematic operations of the information processing devices 10 which form the cooperation networks 2 will be described with reference to FIGS. 2 and 3. FIGS. 2 and 3 are explanatory diagrams illustrating examples of schematic operations of the information processing devices 10 which form a cooperation network 2.

For example, FIG. 2 illustrates an example of a case in which the information processing device 10a configured as a smartphone and the information processing devices 10c and 10d configured as wearable devices operate in cooperation. In addition, in the example illustrated in FIG. 2, the information processing device 10c is configured as a watch type wearable device and is configured to be able to present various kinds of information as video information on a screen or notify of information by audio or vibration. Also, the information processing device 10d is configured as a headphone type device and is configured to be able to output audio information from audio output units (speakers) installed in ear pads.

In addition, in the following description, when a series of information processing devices 10 are specified without particularly specifying one of the information processing devices 10 which form the cooperation networks 2, the “cooperation network 2” is simply described in some cases. For example, when it is described that “a user uses the cooperation networks 2,” the user is assumed to use at least one of the information processing devices 10 which cooperate with one another to form the cooperation network 2.

As illustrated in FIG. 2, in the information processing system 1 according to the embodiment, at least some of the information processing devices 10 which form the cooperation network 2 operate as masters and the other information processing devices 10 operate as slaves.

Specifically, in the information processing system 1 according to the embodiment, the information processing device 10 which can operate as one of a master and a slave and the information processing device 10 which can operate as only a slave can be included as the information processing devices 10 which form the cooperation network 2. For example, in the example illustrated in FIG. 2, the information processing device 10a configured as a smartphone or the information processing device 10c configured as a watch type wearable device (hereinafter simply referred to as a “watch” in some cases) is equivalent to an example of the information processing device 10 which can operate as one of a master and a slave. Also, the information processing device 10d configured as a headphone type device (hereinafter simply referred to as a “headset” in some cases) is equivalent to an example of the information processing device 10 which can operate as only a slave. In addition, the details of the information processing device 10 which can operate as one of a master or a slave and the information processing device 10 which can operate as only a slave will be described separately below.

Then, of the information processing devices 10 which can operate as one of a master and a slave, some information processing devices 10 operate as masters and the other information processing devices 10 operate as slaves. For example, in the example illustrated in FIG. 2, the information processing device 10a (smartphone) operates as a master, and the information processing device 10c (watch) and the information processing device 10d (headset) operate as slaves.

In the cooperation network 2 according to the embodiment, the information processing device 10a operating as the master controls operations of the information processing devices 10 c and 10d operating as the slaves. For example, when a user is notified of information, the information processing device 10a may cause one or both of the information processing devices 10c and 10d to notify of notification target information. As a specific example, when mail is received, the information processing device 10a may cause the information processing device 10c to notify of information for notification of the reception on a screen by a video and may cause the information processing device 10d to notify with sound (audio information) via the audio output unit.

On the other hand, in recent years, with advances in network technologies and diversification of devices used as the information processing devices 10, use situations of the information processing devices 10 which form the cooperation network 2 (for example, states of the information processing devices 10 or users or use environments of the information processing devices 10) have become diverse, and thus the situations may not necessarily be static.

For example, as in a so-called ad hoc network, the cooperation network 2 may be formed by using a technology for autonomously performing routing between proximate devices without depending on base stations and base equipment such as a fixed network linking the base stations to each other. By forming the cooperation network 2 between the plurality of information processing devices 10 using an ad hoc network, it is possible to perform dynamic control such that the information processing device 10 participates in the cooperation network 2 and the information processing device 10 withdraws from the cooperation network 2.

In this way, the present disclosure is not limited to the ad hoc network. Depending on a network connecting the plurality of information processing devices 10, a combination of the information processing devices 10 which form the cooperation network 2 is not commonly fixed.

For example, in the example illustrated in FIG. 3, an example of a case in which the information processing device 10 configured as a tablet terminal participates in the cooperation network 2 illustrated in FIG. 2 is illustrated. Here, when the performance (for example, a processing capability of a CPU, a memory capacity, or communication performance) of the information processing device 10b is greater than the performance of the information processing device 10a, as illustrated in FIG. 3, the information processing device 10b preferably operates as a master instead of the information processing device 10a in some cases.

Also, when a user is notified of information, a preferred mode (for example, whether information is notified by one of a video, audio, and vibration) for notifying of the information differs in some cases depending on a state in which the user uses the cooperation network 2 or an external environment of the cooperation network 2.

As a specific example, as the external environment of the cooperation network 2, there is also a situation in which it is not necessarily preferable to notify of mail arrival or an incoming call as audio information inside a train or the like. In such a situation, for example, it is preferable to notify a user of information by suppressing notification of information by audio information and causing the information processing device 10 that includes a vibration device, such as a smartphone or a watch, to vibrate the vibration device.

Also, as another example, in a situation in which a user is listening to music with a headset, it is not necessarily preferable to output notification information as audio information from a speaker of the headset. That is, in such a situation, for example, by causing the information processing device 10 including a vibration device, such as a smartphone or a watch, to vibrate the vibration device, it is possible to notify a user of information without interrupting the behavior of the user who is “listening to music.”

Also, as still another example, it is not necessarily preferable that the user use a smartphone in some cases, as in a situation in which a user is driving a vehicle. Therefore, for example, in such a situation, it is preferable to notify of information via an in-vehicle speaker or an in-vehicle monitor instead of a smartphone in some cases.

On the other hand, work of changing settings of the information processing device 10 operating as a master, the information processing device 10 caused to notify of various kinds of information, or a method of notifying of the information in accordance with a change in such a situation may be complicated, and a user may feel annoyed in some cases.

Accordingly, the information processing system 1 according to the embodiment provides a structure capable of dynamically changing the configuration of the cooperation network 2 (for example, setting of the information processing devices 10 operating as a master and a slave) or the information processing device 10 notifying of information and a method of notifying of the information in accordance with a use situation of the cooperation network 2. Hereinafter, the details of the information processing system 1 according to the embodiment will be described particularly focusing on the configuration of the cooperation network 2.

### 2. FUNCTIONAL CONFIGURATION

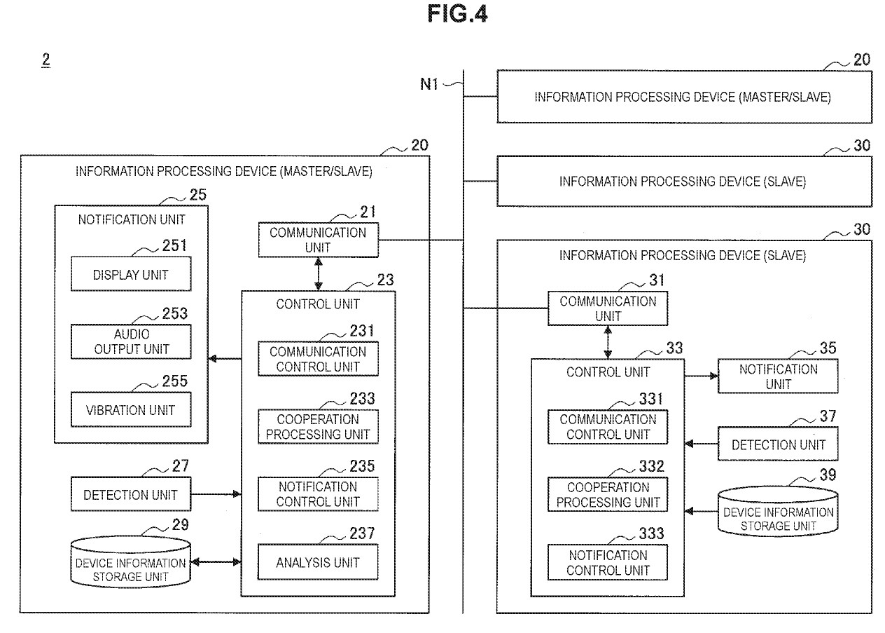

First, referring to FIG. 4, examples of functional configurations of the information processing devices 10 will be described particularly focusing on the information processing devices 10 which form the cooperation network 2 in the information processing system 1 according to the embodiment. FIG. 4 is a block diagram illustrating examples of functional configurations of the information processing devices 10 which form the cooperation network 2 according to the embodiment.

As illustrated in FIG. 4, the cooperation network 2 can include, as the information processing devices 10, information processing devices 20 which can operate as one of a master and a slave and information processing devices 30 which can operate as only a slave. In addition, in the following description, when the information processing devices 20 and 30 are not particularly distinguished from each other, the information processing devices 20 and 30 are referred to as the “information processing devices 10” in some cases.

Also, the number of information processing devices 20 and 30 which form the cooperation network 2 is not limited as long as at least one or more information processing devices 20 are included as the information processing devices 10. As a specific example, the cooperation network 2 may include the plurality of information processing devices 20. Also, the cooperation network 2 may include the plurality of information processing devices 30 in addition to one or more information processing devices 20.

### (Information Processing Device 20)

First, the description will be made focusing on a functional configuration of the information processing device 20 which can operate as any of a master and a slave. The information processing device 20 includes a communication unit 21, a control unit 23, a notification unit 25, and a device information storage unit 29. Also, the information processing device 20 may include a detection unit 27. Also, the control unit 23 includes a communication control unit 231, a cooperation processing unit 233, a notification control unit 235, and an analysis unit 237.

The communication unit 21 is an interface by which each configuration (for example, each configuration of the control unit 23) of the information processing device 20 is connected via the network N1 and which transmits and receives information to and from another information processing device 10. In addition, the mode of the network N1 is not particularly limited, as described above, as long as information can be transmitted and received between the information processing device 20 and another information processing device 10. Also, in the following description, when each configuration of the information processing device 20 transmits and receives information to and from another information processing device 10 via the network N1, information is assumed to be transmitted and received via the communication unit 21 unless otherwise mentioned.

The notification unit 25 is configured to notify a user of information. The notification unit 25 can include at least one of, for example, a display unit 251, an audio output unit 253, and a vibration unit 255.

The display unit 251 is configured to present notification target information as video information (for example, text, a still image, or a moving image). The display unit 251 can be configured by, for example, a display such as a liquid crystal display (LCD) device or an organic light emitting diode (OLED) display.

The audio output unit 253 is configured to output notification target information as audio information such as sound. The audio output unit 253 can be configured by, for example, a speaker.

The vibration unit 255 is configured to present notification target information as a vibration pattern in such a manner that the vibration unit 255 vibrates. The vibration unit 255 can be configured by, for example, a device such as a vibrator which is driven to vibrate.

In addition, the display unit 251, the audio output unit 253, and the vibration unit 255 are merely examples. The configuration included in the notification unit 25 and used to notify a user of information or the notification method is not particularly limited as long as the user can be notified of notification target information. As a specific example, the notification unit 25 may have a configuration for notifying a user of predetermined information by a lighting or blinking pattern, as in a light emitting diode (LED).

The detection unit 27 can have a configuration for acquiring various kinds of information to recognize at least one of a state of the information processing device 20, an external environment of the information processing device 20, and a state of a user using the information processing device 20.

For example, as a configuration for acquiring information for recognizing the state of the information processing device 20, the detection unit 27 may include any of various sensors, such as an acceleration sensor or an angular velocity sensor, capable of detecting a change in a position or a direction of a predetermined casing (for example, the casing of the information processing device 20).

Also, the detection unit 27 may have a configuration for acquiring positional information indicating the position of the information processing device 20. In addition, as the configuration for acquiring the positional information, the Global Positioning System (GPS), the Global Navigation Satellite System (GLONASS), and the Quasi-Zenith Satellites System (QZSS) can be exemplified. In addition, as an example of the QZSS, a system in which the first-made quasi-zenith satellite “MICHIBIKI (registered trademark)” is used can be exemplified.

Also, the detection unit 27 may include any of various sensors that acquire information to detect a state of a user. In addition, as the sensor that acquires the information to detect the state of the user, for example, a temperature sensor that detects the body temperature of a user or a pulse wave sensor that detects a heart rate or a pulse rate of a user can be exemplified.

Also, the detection unit 27 may include any of various sensors that acquire information to recognize an external environment of the information processing device 20. As the various sensors that acquire the information to recognize the external environment, for example, a temperature sensor that measures temperature, a pressure sensor that measures barometric pressure, and a humidity sensor that measures humidity can be exemplified.

Also, as another example, the detection unit 27 may include a sound collection device (for example, a microphone) that collects external environmental sounds of the information processing device 20.

Also, the configurations of the detection unit 27 described above are merely examples. That is, the configuration of the detection unit 27 or a method of acquiring information in the configuration is not particularly limited as long as information can be acquired to detect at least one of the state of the information processing device 20, the external environment of the information processing device 20, and the state of the user using the information processing device 20.

In addition, FIG. 4 illustrates an example in which the notification unit 25 and the detection unit 27 are contained in the information processing device 20, but the present disclosure is not necessarily limited to the example illustrated in FIG. 4. As a specific example, at least a part of the configuration of the notification unit 25 and the detection unit 27 may be externally attached to the information processing device 20.

The communication control unit 231 is a control unit that controls an operation of the communication unit 21. The communication control unit 231 performs a predetermined communication protocol with another information processing device 10 connected via the network N1 to establish communication with the other information processing device 10. In addition, in the following description, the other information processing device 10 connected via the network N1 is referred to as “an external information processing device 10” in some cases.

As an example of the predetermined communication protocol, a pairing process based on Bluetooth (registered trademark) or a process of enabling an access point (AP) and a station (ST) to recognize each other on the basis of the Wi-Fi (registered trademark) standard to establish communication can be exemplified. Also, the communication control unit 231 may receive a predetermined manipulation (for example, pressing a button) on one or both of the information processing device 20 and the external information processing device 10 and establish communication with the information processing device 10, such as so-called Wi-Fi protected setup-push button configuration (WPS-PBC).

Also, when the communication control unit 231 newly establishes communication with the external information processing device 10, the communication control unit 231 may be configured to notify a predetermined notification destination (for example, the cooperation processing unit 233 to be described below) of the establishment of the communication. For example, when the communication control unit 231 notifies the cooperation processing unit 233 of the establishment of the communication, the cooperation processing unit 233 can recognize that the external information processing device 10 newly participates in the cooperation network 2.

Also, the communication control unit 231 may monitor whether the communication with the external information processing device 10 continues by periodically transmitting and receiving predetermined information to and from the external information processing device 10. Then, when the communication established with some of the information processing devices 10 is disconnected (for example, when a period in which a response is not acquirable continues for a predetermined time or more), the communication control unit 231 may detect the disconnection of the communication on the basis of a monitoring result and notify the cooperation processing unit 233 of a detection result.

In such a configuration, the cooperation processing unit 233 notified of the detection result can recognize disconnection of the communication when the communication with at least some of the information processing devices 10 among the external information processing devices 10 is disconnected. In other words, on the basis of the notification, the cooperation processing unit 233 can recognize that some of the information processing devices 10 withdraw from the cooperation network 2.

The analysis unit 237 is configured to recognize various states such as a state of the cooperation network 2 or the information processing device 10 which forms the cooperation network 2, an external environment of the cooperation network 2, and a state of a user using the cooperation network 2.

The analysis unit 237 may recognize a state of a user or a behavior of the user on the basis of a so-called behavior recognition technology using various kinds of information acquired from at least one of the detection unit 27 and the external information processing device 10, information regarding an application which is being executed, or the like as input information.

As a specific example, the analysis unit 237 can recognize whether the user is moving (for example, walking) on the basis of the behavior recognition technology using information detected by the detection unit 27 or an acceleration sensor or an angular velocity sensor included in the external information processing device 10 as input information. Also, at this time, the analysis unit 237 may identify whether the user is walking or running in accordance with a detection result (for example, a vibration direction or a vibration period) of the acceleration sensor or the angular velocity sensor.

Also, when the analysis unit 237 detects that the user is moving on the basis of positional information detected by GPS or the like (for example, positional information regarding the information processing device 10 which forms the cooperation network 2) although the user is not moving, the analysis unit 237 can recognize that the user is moving by a vehicle, a train, or the like. Also, in this case, the analysis unit 237 may recognize a movement path of the user on the basis of the positional information detected by GPS or the like and recognize a movement unit (that is, one of a vehicle and a train) of the user on the basis of the recognized movement path.

Also, as another example, when the analysis unit 237 recognizes that an application of an electronic book is being executed on the basis of a use ratio of each application, the analysis unit 237 can recognize that the user is “reading” using the “electronic book.” Also, as still another example, when the analysis unit 237 recognizes that an application for “coaching” in training is being executed on the basis of a use ratio of each application, the analysis unit 237 can recognize that the user is “training (for example, running).”

Also, the analysis unit 237 may recognize an external environment of the cooperation network 2 (in other words, an external environment of the user using the cooperation network 2) on the basis of various kinds of information acquired by at least one of the detection unit 27 and the external information processing device 10.

As a specific example, the analysis unit 237 can recognize an environment in which the user is located (for example, a home or business) on the basis of positional information detected by GPS or the like. Also, the analysis unit 237 may recognize the position of a home or business of the user on the basis of a history of positional information regarding the user during a specific period of time. As specific example, the analysis unit 237 may recognize a position at which the user is most frequently located as the position of the home of the user on the basis of a history of positional information regarding the user at night. Similarly, the analysis unit 237 may recognize a position at which the user is most frequently located as the position of the business of the user on the basis of a history of positional information of the user in the daytime on weekdays.

Also, as still another example, the analysis unit 237 may estimate climate or weather around the user on the basis of information regarding air temperature, temperature, barometric pressure, and the like detected by various sensors.

Also, the analysis unit 237 may recognize a state of the user's surroundings on the basis of environmental sounds collected by a sound collection device (for example, a microphone). As a specific example, the analysis unit 237 may recognize the density of people around the user on the basis of a level (volume) or a signal-to-noise ratio (SN ratio) of environmental sounds collected by a sound collection device. Also, as another example, the analysis unit 237 may recognize whether an environment around the user is an environment in which it is necessary for the user to behave quietly (a so-called quiet environment) on the basis of a level (volume) or an SN ratio of environmental sounds collected by a sound collection device (for example, a microphone).

Also, the analysis unit 237 may access the cooperation server 5 and use information detected in another cooperation network 2. As a specific example, the analysis unit 237 may recognize whether a crowd is dense near the position of the user recognized on the basis of a detection result of GPS or the like by acquiring positional information regarding other users from the cooperation server 5 (in other words, the density of the crowd may be recognized).

Also, as another example, the analysis unit 237 may acquire information regarding weather of an area in which the user is located (that is, an area included in the recognized positional information) from the cooperation server 5 on the basis of the recognized positional information regarding the user.

Also, the analysis unit 237 may monitor a state of the information processing device 10 which forms the cooperation network 2 (that is, a state of the information processing device 20 or the external information processing device 10) or various kinds of information (for example, various parameters) and may recognize the state of each information processing device 10 on the basis of a detection result. In particular, the analysis unit 237 may use a state that changes in accordance with a use status of the user in the state of each information processing device 10 as a monitoring target. As a specific example, the analysis unit 237 may monitor a remaining battery amount of the information processing device 20 or the external information processing device 10 and recognize whether the information processing device 20 or the external information processing device 10 is being battery-driven on the basis of the monitoring result. Also, the analysis unit 237 may recognize a predetermined state by combining another piece of information and a recognition result obtained in accordance with whether a battery is being charged. As a specific example, the analysis unit 237 may record a history of the positional information regarding the information processing device 20 when a battery is being charged and may recognize a position at which a charging frequency is high as the home of the user on the basis of the history.

Also, the analysis unit 237 may recognize a use state of each information processing device 10 which forms the cooperation network 2 (that is, whether the user is using each information processing device). As a specific example, the analysis unit 237 may recognize the information processing device 10 which is temporarily stopped as in a so-called sleep mode as the information processing device which is not used by the user.

Also, when a wearing state of the information processing device 10 such as a so-called wearable device can be detected, the analysis unit 237 may recognize whether the information processing device 10 is worn by the user in accordance with the wearing state. That is, when the information processing device 10 configured as a wearable device is worn by the user, the analysis unit 237 may recognize that the information processing device 10 is being used by the user.

In this way, the analysis unit 237 recognizes various states such as a state of the cooperation network 2 or the information processing device 10 which forms the cooperation network 2, an external environment of the cooperation network 2, and a state of the user using the cooperation network 2 and notifies the cooperation processing unit 233 of a recognition result.

The device information storage unit 29 is a storage unit that stores device information regarding the information processing device 10. In addition, device information regarding the information processing device 20 including the device information storage unit 29 may be stored in advance in the device information storage unit 29. Also, a profile table generated by the cooperation processing unit 233 to be described below may be stored in the device information storage unit 29 on the basis of the device information stored in the device information storage unit 29 and device information regarding the external information processing device 10. In addition, the details of the profile table will be described separately below along with the details of the cooperation processing unit 233.

The cooperation processing unit 233 acquires the device information regarding the information processing device 20 from the device information storage unit 29. Also, the cooperation processing unit 233 acquires the device information regarding the information processing device 10 from each external information processing device 10. In addition, at this time, when the device information may not be acquired from the external information processing device 10, the cooperation processing unit 233 may acquire the device information regarding the information processing device 10 from the cooperation server 5.

Then, the cooperation processing unit 233 generates the profile table on the basis of the device information regarding each of the information processing device 20 and the external information processing device 10 and stores the generated profile table in the device information storage unit 29.

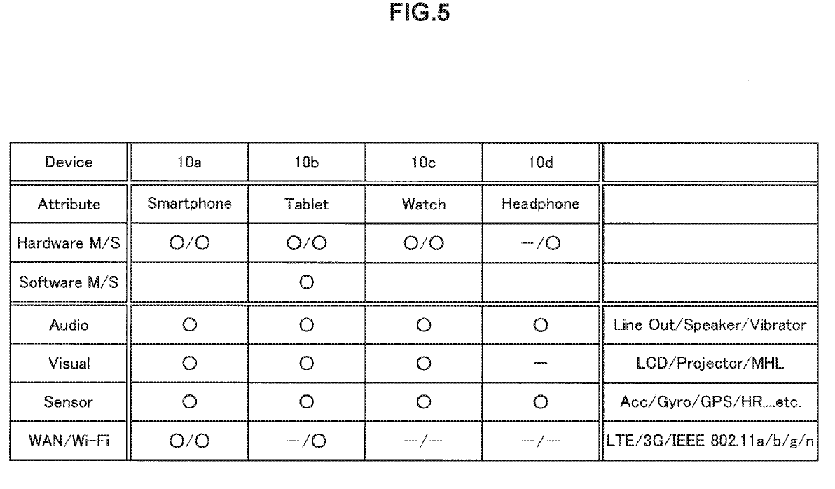

For example, FIG. 5 is a diagram illustrating an example of a profile table. In the example illustrated in FIG. 5, the profile table includes attributes of the corresponding information processing devices 10, information indicating whether the information processing device can operate as a master or a slave, and information indicating corresponding states to various functions. Also, the profile table (in other words, device information) may include performance information regarding various functions. In addition, the performance information regarding various functions is equivalent to an example of “information indicating performance” of the corresponding device.

In addition, the information indicating whether the information processing device can operate as a master or a slave includes information (hardware M/S) indicating whether the information processing device can operate as a hardware master and information (software M/S) indicating the information processing device operates as a software master.

Here, the hardware master indicates a master that first operates in initial setting when communication is established between the information processing devices 10 which form the cooperation network 2. The hardware master can be equivalent to, for example, the information processing device 10 can be equivalent to the information processing device 10 which can autonomously operate in a protocol for establishing communication such as pairing based on the Bluetooth (registered commercial law) standard. For example, when some of the information processing devices 10 receive a user manipulation of forming the cooperation network 2, these information processing devices 10 may start an operation as the hardware masters using the user manipulation as a trigger.

Also, the software master is equivalent to a master designated by the hardware master on the basis of the device information regarding each information processing device 10. That is, after the cooperation network 2 is completely formed and the software master is designated by the hardware master, the software master operates as an actual master.

Also, the attribute of the information processing device 10 is information for classifying each of the cooperation target information processing devices 10 in accordance with functions or uses and whether the information processing device is a device which can operates as a master (a hardware master or a software master) is classified on the basis of the attribute. Also, in the information processing system 1 according to the embodiment, priority between the information processing devices 10 is set in accordance with the attributes set in the information processing devices 10 an the information processing device 10 operating as a master is decided in accordance with the priority.

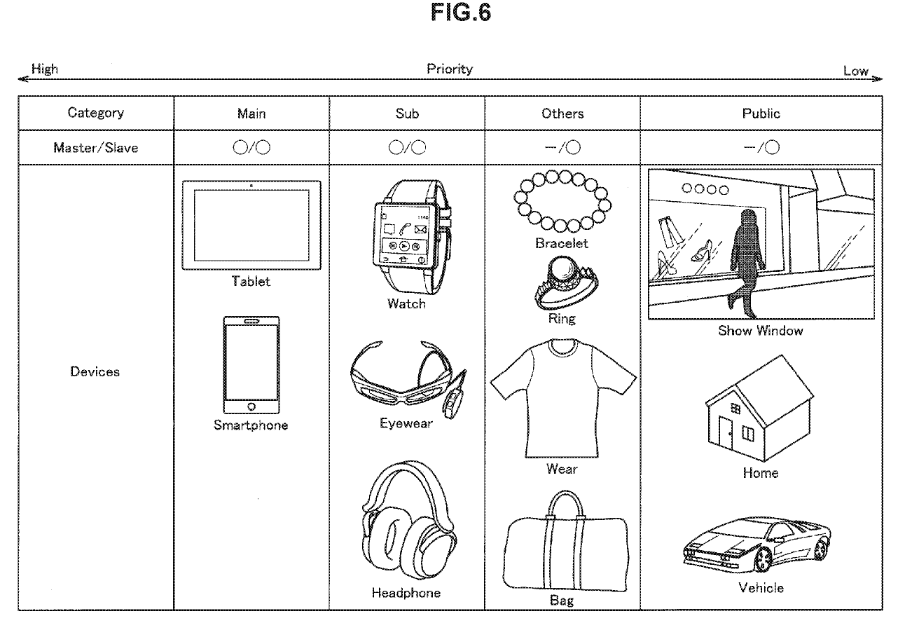

For example, FIG. 6 is a diagram illustrating examples of the attributes set in the information processing devices 10 and setting of the priority between the attributes. In the examples illustrated in FIG. 6, the information processing devices 10 are classified into “Main,” “Sub,” “Others,” and “Public” in accordance with the attributes set in the information processing devices 10.

The information processing devices 10 classified as “Main” are the information processing devices 10 which have a tendency to be mainly used as main terminals such as a smartphone or a tablet terminal and can perform various processes even individually.

The information processing devices 10 classified as “Sub” are the information processing devices 10 which cooperate with the information processing devices 10 classified mainly as “Main” to operate, as in so-called wearable devices such as a headset. In addition, the information processing devices 10 classified as “Sub” may be, for example, the information processing devices 10 which can individually operate in accordance with situations as in some wearable devices (for example, a watch).

The information processing devices 10 classified as “Others” are equivalent to the information processing devices 10 which are not classified “Main” or “Sub” among the various information processing devices 10 used by users. In particular, the information processing devices 10 classified as “Others” are mainly information processing devices (devices) which cooperate with the information processing devices 10 classified as “Main” or “Sub” to operate. As specific examples of the information processing devices 10 classified as “Others,” devices (for example, devices contained in clothes or decorations) which contain sensors to detect various states and notify the other information processing devices 10 which operate in cooperation of detection results of the sensors can be exemplified.

The information processing devices 10 classified as “Public” are equivalent to devices which are installed in specific facilities or regions and cooperate with the information processing devices 10 located nearby to operate as in electric devices in homes, equipment in homes, devices in automobiles, or devices installed in public spaces.

In the information processing system 1 according to the embodiment, the priority of the information processing devices 10 set as “Main” is the highest and the priority is set in the order of “Main,” “Sub,” “Others,” and “Public.” In addition, as will be described below in details, the information processing device 10 with higher priority is selected as a master more preferentially. Also, in the information processing system 1 according to the embodiment, the information processing device 10 classified as “Main” or “Sub” can operate as any of a master and a slave and the information processing device 10 classified as “Others” and “Public” operates as only a slave.

Also, in the example of the profile table illustrated in FIG. 5, correspondence states of the information processing devices 10 to various functions are illustrated. Specifically, correspondence states of the information processing devices 10 to functions, that is, “Audio” and “Visual” functions related to information notification, a “Sensor” function related to state detection, and a network function “WAN/Wi-Fi,” are illustrated.

The “Audio” function is a function of outputting audio information such as sound. As specific examples, a “line output (Line Out),” a “speaker output (Speaker),” and a “vibration output (Vibrator)” can be exemplified. In addition, in the example illustrated in FIG. 5, as the “Audio” function, only a correspondence situation to a function of outputting audio information is simply indicated. However, an individual correspondence situation may also be indicated in regard to each of the “line output (Line Out),” the “speaker output (Speaker),” and the “vibration output (Vibrator).”

The “Visual” function is a function of outputting video information such as text information, a still image, and a moving image. As specific examples, a “liquid crystal output (LCD),” a “projector output (Projector),” and an “MHL output (MHL: mobile high-definition link)” can be exemplified. In addition, in the example illustrated in FIG. 5, as the “Visual” function, only a correspondence situation to a function of outputting video information is simply indicated. However, an individual correspondence situation may also be indicated in regard to each of the “liquid crystal output (LCD),” the “projector output (Projector),” and the “MHL output (MHL: mobile high-definition link).”

The “Sensor” function is a function of detecting various states. As specific examples, detection function such as “acceleration detection (Acc),” “angular velocity detection (Gyro),” “position detection (GPS),” and “heart rate detection (HR: heart rate)” can be exemplified. In addition, in the example illustrated in FIG. 5, as the “Sesor” function, only a correspondence situation to a function of detecting various states is simply indicated. However, an individual correspondence situation may also be indicated in regard to each detection function such as “acceleration detection (Acc),” “angular velocity detection (Gyro),” “position detection (GPS),” and “heart rate detection (HR: heart rate).”

The “WAN/Wi-Fi” indicates whether to correspond to each of wide area network (WAN) and Wi-Fi as a network function. In addition, as the network function, a network function or the like based on a standard such as Long Term Evolution (LTE) or the 3rd mobile communication system (3G) or an IEEE 802.11a/b/g/n standard can be exemplified.

By generating the profile table in the foregoing way, the cooperation processing unit 233 can recognize correspondence situations of the information processing device 20 and the external information processing device 10 to the attributes or the functions on the basis of the generated profile table.

In addition, the cooperation processing unit 233 may store the generated profile table in the device information storage unit 29. In the following description, when the “profile table” is described, the profile table is assumed to be a profile table generated in advance by the cooperation processing unit 233 and stored in the device information storage unit 29 unless otherwise mentioned.

Also, the cooperation processing unit 233 may update the profile table in accordance with a communication state with the external information processing device 10. As a specific example, when the external information processing device 10 is newly added to the cooperation network 2, the cooperation processing unit 233 may acquire device information regarding the information processing device and add the acquired device information to the profile table.

Also, in the cooperation processing unit 233, some of operations differ in accordance with whether the information processing device 20 operates as a hardware master, a software master, or a slave. Accordingly, the details of operations of the cooperation processing unit 233 when the information processing device 20 operates as a hardware master, a software master, and a slave will be described below.

### (When Information Processing Device Operates as Hardware Master)

First, an operation of the cooperation processing unit 233 when the information processing device 20 operates as a hardware master will be described.

When the information processing device 20 can operate as a hardware master, the cooperation processing unit 233 first causes the information processing device 20 to operate as the hardware master and gives an instruction to the external information processing devices 10 so that the external information processing devices 10 operates as slaves. Each of the external information processing devices 10 receiving this instruction operate as the slaves.

In addition, at this time point, since the information processing device 20 operates as the master, an application which causes the information processing devices 10 included in the cooperation network 2 to cooperate (hereinafter referred to as a “cooperation application” in some cases) is executed by the information processing device 20.

Subsequently, the cooperation processing unit 233 specifies the information processing device 10 operating as a software master from the information processing device 20 and the external information processing devices 10 on the basis of the profile table generated in advance.

Specifically, when there is the information processing device 10 with a higher attribute or specification (for example, performance) than the information processing device 20 among the external information processing devices 10 on the basis of the profile table, the cooperation processing unit 233 operates the information processing device 10 as a software master (that is, transfers to an operation of the master). As a specific example, when there is the information processing device 10 with higher priority than the information processing device 20 among the external information processing devices 10 on the basis of the prioritization illustrated in FIG. 6, the information processing device 10 operates as the software master. In addition, in this case, the cooperation processing unit 233 causes the information processing device 20 to operate as a slave.

In addition, when there is no information processing device 10 with a higher attribute or specification (for example, performance) than the information processing device 20 among the external information processing devices 10, the cooperation processing unit 233 causes the information processing device 20 to operate as a software master.

In this way, after the information processing device 10 operating as the software master is designated on the basis of the profile table, the information processing device 10 designated as the software master operates as an actual master. In addition, after the software master is decided, the cooperation application is executed on the information processing device 10 operating as the software master.

The details of the operation of the cooperation processing unit 233 when the information processing device 20 operates as the hardware master have been described above.

### (When Information Processing Device Operates as Software Master)

Next, details of an operation of the cooperation processing unit 233 when the information processing device 20 operates as the software master will be described.

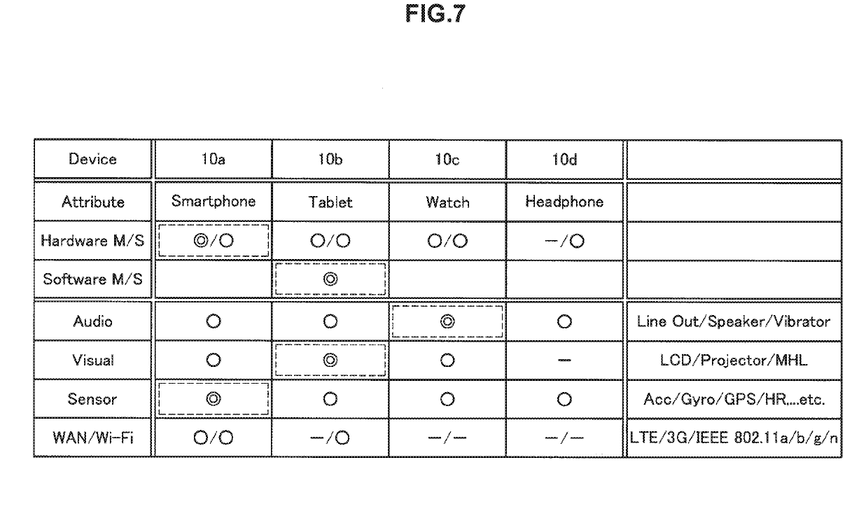

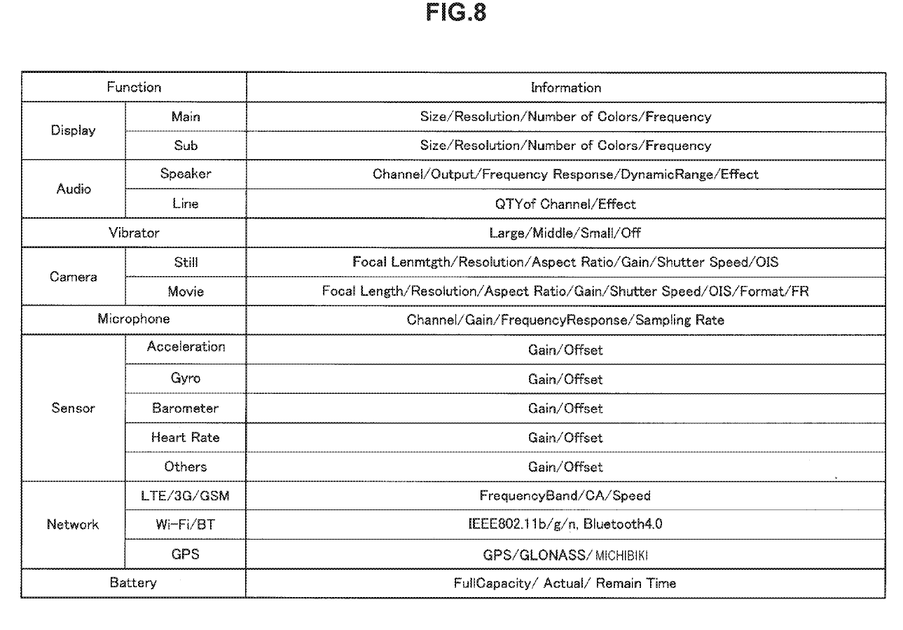

First, for each function (for example, each information notification method) related to information notification, the cooperation processing unit 233 decides the information processing device 10 caused to perform the function among the information processing devices 10 which form the cooperation network 2 on the basis of the profile table, as initial setting for information notification. Accordingly, an operation of the cooperation processing unit 233 related to setting for information notification will be described with reference to FIGS. 7 and 8 particularly focusing on an operation related to the initial setting. FIGS. 7 and 8 are explanatory diagrams illustrating an operation of the cooperation processing unit 233 related to setting for information notification. In addition, content set as the initial setting is default setting for the information notification. Also, hereinafter, the setting for the information notification is simply referred to as “notification setting” and particularly the initial setting for the information notification is referred to as “default notification setting” in some cases.

For example, FIG. 7 is an explanatory diagram illustrating an operation of the cooperation processing unit 233 related to setting for information notification and illustrates an example of notification setting based on the profile table illustrated in FIG. 5. In the example illustrated in FIG. 7, the information processing device 10b (the tablet terminal) designated by the information processing device 10a (the smartphone) operating as a hardware master operates as a software master.

For example, when the “Visual” function is focused on, the cooperation processing unit 233 calculates a performance value Spec of each information processing device 10 for each item of performance information set in advance for the “Visual” function. For example, as the items of the performance information corresponding to the “Visual” function, a “screen size,” a “resolution,” the “number of colors,” and “frequency (in other words, a frame rate)” can be exemplified. Also, when a value indicating the performance of the information processing device 10 operating as the software master is assumed to a “reference value” and a value indicating the performance of the information processing device 10 which is a calculation target of the performance value Spec is assumed to be a “compared value,” the performance value Spec is calculated by normalizing the compared value using the reference value. That is, the performance value Spec is calculated on the basis of a calculation equation indicated by the following (Equation 1).

### [Math. 1]

Spec=(Compared value)/(Reference Value)×(Coefficient) . . . (Equation 1)

In addition, “Coefficient” in (Equation 1) is a coefficient for adjusting the performance value Spec to be calculated and may be adjusted appropriately in accordance with a processing amount related to various calculations by the cooperation processing unit 233.

Here, as a specific example, a case in which the information processing device 10b (the tablet terminal) operating as the software master calculates the performance value Spec of the information processing device 10a (the smartphone) operating as the slave in regard to a resolution will be described.

When the resolution of a display of the information processing device 10b operating as the software master is assumed to be 1080p, a reference value indicating performance in regard to the resolution of the information processing device 10b is 1080p=1920×1080=2073600. Also, when the resolution of a display of the information processing device 10a is assumed to be 1080p, the compared value indicating performance in regard to the resolution of the information processing device 10a is 720p=1280×720=921600.

When the coefficient in (Equation 1) is assumed to be 10, the performance value Spec in regard to the resolution of the information processing device 10b is Spec=720p/1080p×10=921600/2073600×10=4.4.

In this way, the cooperation processing unit 233 calculates the performance value Spec of each information processing device 10 for each item of the performance information corresponding to the “Visual” function.

Subsequently, the cooperation processing unit 233 performs ranking between the information processing devices 10 which form the cooperation network 2 on the basis of the performance value Spec of each information processing device 10 calculated in regard to an item for each item of the performance information (that is, sets ranks).

Then, the cooperation processing unit 233 calculates device ranks between the information processing devices 10 which form the cooperation network 2 for each of the information processing devices 10 on the basis of the ranking of each item of the performance information. Here, the device rank of each information processing device 10 is calculated on the basis of the following (Equation 2) using the rank of each item of the performance information corresponding to the information processing device 10 as input information.

$$\begin{matrix}[ Math . 2 ] & \\ DeviceRank = \frac{ \begin{matrix}( Rank of Spec 1 ) \times ( Rank of \\ Spec 2 ) \times ⋯ \times ( Rank of SpecN )\end{matrix}}{Number of items N} & ( Equation 2 )\end{matrix}$$

In addition, each of Spec1 to SpecN in (Equation 2) indicates the performance value Spec calculated for each item of the performance information.

As a specific example, when a device rank corresponding to the “Visual” function is calculated, the cooperation processing unit 233 calculates the performance values Spec (that is, Spec1 to Spec4) of four items (that is, N=4) of the “screen size,” the “resolution,” the “number of colors,” and the “frequency.” Then, on the basis of the calculated Spec1 to Spec4, the cooperation processing unit 233 performs ranking between the information processing devices 10 for each item of the performance information and calculates the device ranks corresponding to the “Visual” function of the information processing devices 10 by inputting results of the ranking into (Equation 2) for the respective information processing devices 10.

Then, the cooperation processing unit 233 sets the priority between the information processing devices 10 on the basis of the device rank calculated for each of the information processing devices 10 which form the cooperation network 2 and decides the information processing device 10 caused to perform the “Visual” function on the basis of the priority. For example, in the example illustrated in FIG. 7, the cooperation processing unit 233 sets the information processing device 10b as the information processing device 10 caused to perform the “Visual” function (that is, notifies information by video information).

In addition, at this time, the cooperation processing unit 233 may decide whether to use the “liquid crystal output (LCD),” the “projector output (Projector),” or the “MHL output (MHL)” as an output of the video information on the basis of, for example, setting by the user.

Similarly, the cooperation processing unit 233 calculates the device rank of each of the information processing devices 10 which form the cooperation network 2 similarly even in another function (for example, the “Audio” function or the “Sensor” function) and sets the information processing device 10 caused to perform the function on the basis of the device rank.

For example, in the example illustrated in FIG. 7, the cooperation processing unit 233 sets the information processing device 10c as the information processing device 10 caused to perform the “Audio” function (that is, notify information by audio information). In addition, as examples of the items of the performance information corresponding to the “Audio” function, the “size of an output unit (for example, a speaker),” “maximum volume,” a “dynamic range,” the “number of channels,” and a “type (for example, bone conduction or not)” can be exemplified.

At this time, the cooperation processing unit 233 may decide whether to use the “line out (Line Out),” the “speaker output (Speaker),” or the “vibration output (Vibrator)” as an output of the audio information, for example, on the basis of setting by the user or a setting state such as a silent mode.

Also, the cooperation processing unit 233 sets the information processing device 10a as the information processing device 10 caused to perform the “Sensor” function (that is, detect various kinds of information).

In this way, the default notification setting is completed. In addition, the functions performed by the information processing devices 10 which form the cooperation network 2 or the items of the performance information set in advance in the functions, as described above, are merely examples, and the present disclosure is not limited to the foregoing examples. For example, FIG. 8 illustrates examples of functions performed by the information processing devices 10 which form the cooperation network 2 or items of the performance information set in advance in the functions.

As a specific example, the cooperation processing unit 233 may perform control such that the information processing device 10 which forms the cooperation network 2 is caused to perform a function (for example, a “Vibrator” function) of outputting tactile information for presenting a sense of pseudo-touch or force to the user by performing vibration as in a so-called vibrator (for example, the vibration unit 255 of FIG. 4). As examples of the items of the performance information corresponding to the “Vibrator” function, a “dynamic range of vibration,” a “maximum amplitude,” and a “type (for example, an eccentric motor, a voice coil, electric stimulation, or stimulation by temperature)” can be exemplified. In addition, a device (for example, the vibration unit 255) that outputs tactile information for presenting a sense of pseudo-touch or force to the user is equivalent to an example of a “tactile presentation unit.”

When the default notification setting is completed, the cooperation processing unit 233 acquires information regarding the user and updates the notification setting in accordance with the acquired information regarding the user.

In addition, as the information regarding the user, information regarding various states such as the state of the cooperation network 2 used by the user or the information processing devices 10 which form the cooperation network 2, the external environment of the cooperation network 2, and the states of the users (in other words, various situations) can be exemplified. The cooperation processing unit 233 may acquire such information from, for example, the analysis unit 237. Also, the cooperation processing unit 233 may acquire such information from the external information processing device 10.

Also, the cooperation processing unit 233 may acquire the information regarding the user from information (for example, notification target information such as a mail) of which the user is notified. As a specific example, when a mail is received as notification target information, the cooperation processing unit 233 may acquire information indicating a transmission source of the mail as the information regarding the user. Also, the cooperation processing unit 233 may acquire information indicating a type of information notification medium (for example, information indicating notification related to a mail, a message function, a notification call, coupon updating, or the like) or information indicating types of at least some pieces of information (text information, image information, and the like) included in the notified information as the information regarding the user. Also, when priority of information such as mails is associated by the user, the cooperation processing unit 233 may acquire information indicating the priority as the information regarding the user. In addition, the information regarding the user acquired from the information of which the user is notified, as described above, is equivalent to an example of “information regarding information of which a user is notified.”

In addition, an opportunity for the cooperation processing unit 233 to acquire the information regarding the user is not particularly limited. As a specific example, the cooperation processing unit 233 may acquire the information regarding the user for each timing decided in advance. Also, as another example, when a predetermined process is performed, the cooperation processing unit 233 may acquire the information regarding the user in tandem with the process. Also, the cooperation processing unit 233 may acquire the information at another opportunity in accordance with the type of information regarding the user.

Then, when a state corresponding to a pre-decided condition (hereinafter referred to as an “exception condition” in some cases) is detected on the basis of the acquired information regarding the user, the cooperation processing unit 233 updates the notification setting in accordance with the detected state as an exception process. Also, at this time, the cooperation processing unit 233 may update the priority set between the information processing devices 10 in accordance with the detected state and update the notification setting on the basis of the updated priority (that is, may decide the information processing device 10 caused to notify of information on the basis of the updated priority).

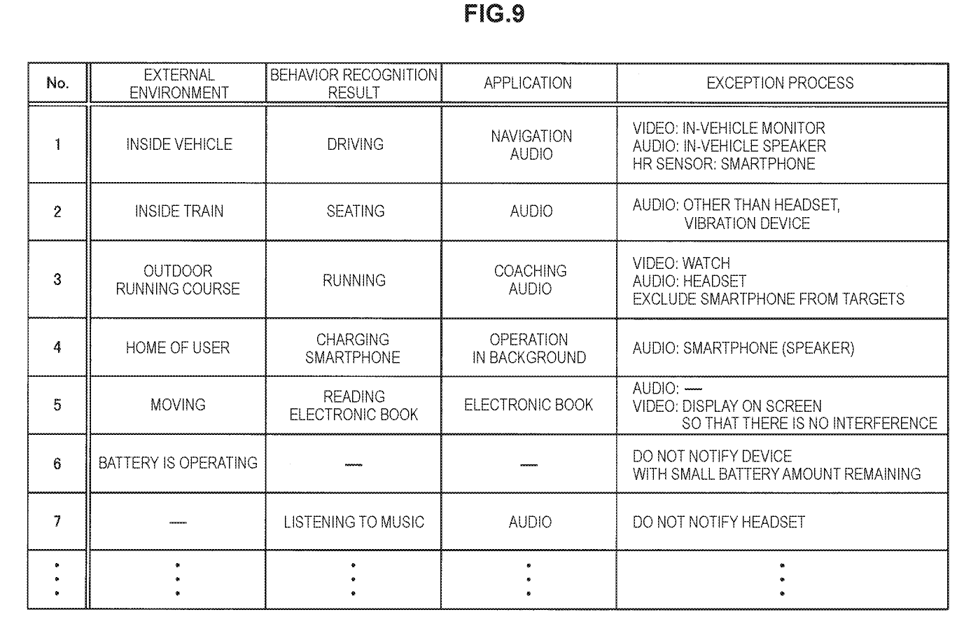

For example, FIG. 9 is a diagram illustrating an example of a correspondent relation between states corresponding to exception conditions and exception processes performed in accordance with the states. In the example illustrated in FIG. 9, states corresponding to the exception conditions are defined on the basis of at least one of an outside environment, a behavior recognition result (that is, a behavior or a state of the user), and an application which is being executed.

As a specific example, in FIG. 9, an exception condition shown as “No. 1” indicates a state in which an external environment is “inside vehicle,” the user is recognized as being “driving,” an application of “navigation” or “audio” is being executed. When such a state is detected, the cooperation processing unit 233 updates the notification setting so that an in-vehicle monitor is allocated to information notification (the “Visual” function) by video information and an in-vehicle speaker is allocated to information notification (the “Audio” function) by audio information. Also, at this time, the cooperation processing unit 233 may monitor a state of the user by validating an HR sensor of a smartphone and causing the smartphone to detect a heart rate of the user as the “Sensor” function.

Also, an exception condition shown as “No. 2” indicates a state in which the external environment is “inside train,” the user is recognized as being “seating,” and an application of “audio” is being executed. When such a state is detected, the cooperation processing unit 233 updates the notification setting so that a device other than a headset is allocated to the information notification (the “Audio” function) by audio information. Also, the cooperation processing unit 233 may update the notification setting so that information is notified of by vibrating the vibration device instead of the information notification by the audio information.

Also, the cooperation processing unit 233 may exclude some of the information processing devices 10 from targets to be allocated to functions according to a condition. For example, the exception condition shown as “No. 3” indicates that the user is “running” along an “outdoor running course.” In this case, the cooperation processing unit 233 excludes a smartphone from the targets to which functions related to the information notification are allocated and allocates a “watch type wearable device (watch)” or a “headset” to the function.

In addition, the example illustrated in FIG. 9 is merely an example. It is needless to say that the correspondent relation between the states corresponding to the exception conditions and the exception processes performed in accordance with the states is not limited to the example illustrated in FIG. 9.

For example, the cooperation processing unit 233 may suppress the information notification (the “Audio” function) by the audio information when a surrounding environment of the user is considerably noisy or is conversely considerably silent. In this way, the cooperation processing unit 233 may set or update the priority between the functions (for example, between functions for the information notification) when a state corresponding to a predetermined exception condition is detected.

Also, the cooperation processing unit 233 may control an information notification method in accordance with temperature or climate of an environment around the user. As a specific example, under an environment in which the user may feel cold, there is a high possibility of the user wearing many clothes and the user may feel troublesome in an operation of taking out the information processing device 10 such as a smartphone. Therefore, when the temperature of the environment around the user is lower than predetermined temperature or the climate is rain or snow, the cooperation processing unit 233 may raise the priority of the information processing device 10 such as wearable device retained in a part of the body of the user and serving as the information processing device 10 caused to notify of information.

Also, as another example, when information is notified of from a so-called network service, the cooperation processing unit 233 may control the information notification method in accordance with the type of network service (that is, a notification source). Also, the cooperation processing unit 233 may change an mode for notifying notification target information in accordance with a use situation of a medium for referring to notified information as in network service or mail software. As a specific example, when information is received from a notification source in which the user instantly responds to notification reception, the cooperation processing unit 233 may change the notification method so that the information can be identified from other information (for example, the information is emphasized more than other information). Also, the cooperation processing unit 233 may perform control such that information such as information in which high priority is set in advance as in so-called disaster notification or information from the family of the user is notified by a notification method different from other information.

Of course, it is needless to say that exceptional conditions are defined by combining the above-described various conditions and exception processes corresponding to the exception conditions are defined. For example, the exception conditions may be defined by combining a plurality (some or all) of items among a “user behavior (that is, a behavior recognition result),” an “external environment,” an “application which is being executed,” “information regarding information of which the user is notified,” and a “device state changed in accordance with a use situation of the user.” As a specific example, when a mail to a user is received, the cooperation processing unit 233 may switch the information processing device 10 or the notification method of notifying of reception of the mail in accordance with the recognized behavior of the user. Similarly, when the user is moving by train and information to the user is received, the cooperation processing unit 233 may switch the information processing device 10 or the notification method of notifying of reception of the information in accordance with a notification medium of the received information (for example, a mail or a telephone), a transmission source of the information (for example, a relative or not), and the type of information (for example, text information or image information).

In addition, specific examples of the correspondent relation between the states corresponding to the exception conditions and the exception processes performed in accordance with the states will be described separately as examples.

Also, when information indicating the state corresponding to the exception conditions and the exception processes performed in accordance with the states is stored at a position at which the information can be read by the cooperation processing unit 233, the position at which the information is stored is not particularly limited. As a specific example, the information indicating the state corresponding to the exception conditions and the exception processes performed in accordance with the states may be stored in the information processing device 20 or may be stored in the external information processing device 10. Also, as another example, the information may be stored in the cooperation server 5.

In this way, when the states corresponding to the exception conditions are detected on the basis of information regarding the user, the cooperation processing unit 233 updates the notification setting in accordance with the states detected as the exception processes. In such a configuration, even under a situation in which the use scene of the cooperation network 2 (that is, various states such as the state of the cooperation network 2 or the information processing devices 10 which form the cooperation network 2, the external environment of the cooperation network 2, and the user states) is dynamically changed, the cooperation processing unit 233 can perform control such that the user is notified of the information in an appropriate mode adapted to the use scene.

The details of the operation of the cooperation processing unit 233 when the information processing device 20 operates as the software master have been described above.

### (When Information Processing Device Operates as Slave)

Next, the details of an operation of the cooperation processing unit 233 when the information processing device 20 operates as a slave will be described.

When the information processing device 20 operates as a slave, the cooperation processing unit 233 operates mainly on the basis of an instruction from the external information processing device 10 (for example, the information processing device 10 operating as a software master).

Specifically, the cooperation processing unit 233 transmits the device information stored in the device information storage unit 29 to the information processing device 10 in accordance with the instruction from the external information processing device 10.

Also, the cooperation processing unit 233 may transmit information acquired by the detection unit 27 to the information processing device 10 in accordance with an instruction from the external information processing device 10.

The details of the operation of the cooperation processing unit 233 when the information processing device 20 operates as the slave have been described above.

Next, an operation of the notification control unit 235 will be described. The notification control unit 235 is configured to control an operation related to the information notification. The notification control unit 235 controls the information processing device 10 notifying of information and an information notification method on the basis of the notification setting controlled by the cooperation processing unit 233 at an opportunity to notify the user of the information, such as a case in which an event related to the information notification is detected. In addition, at this time, when the external information processing device 10 is caused to notify of information, the notification control unit 235 transmits notification target information to the information processing device 10 to give an instruction of the information notification method.

Also, when an instruction related to the information notification is received from the external information processing device 10, the notification control unit 235 acquires notification target information from the information processing device 10 and causes the notification unit 25 to notify of the information on the basis of the notification method notified of together.

### (Information Processing Device 30)

Next, the description will be made focusing on the functional configuration of the information processing device 30 operating as only a slave. The information processing device 30 includes a communication unit 31, a control unit 33, a notification unit 35, and a device information storage unit 39. Also, the information processing device 30 may include a detection unit 37. Also, the control unit 33 includes a communication control unit 331, a cooperation processing unit 333, and a notification control unit 335.

The communication unit 31 is an interface by which each configuration (for example, each configuration of the control unit 33) of the information processing device 30 is connected via the network N1 and which transmits and receives information to and from the external information processing device 10. In addition, in the following description, when each configuration of the information processing device 30 transmits and receives information to and from the external information processing device 10 via the network N1, information is assumed to be transmitted and received via the communication unit 31 unless otherwise mentioned.

The notification unit 35 is configured to notify a user of information. In addition, as in the notification unit 25 of the information processing device 20 described above, the notification unit 35 can include at least one of, for example, a display unit 251, an audio output unit 253, and a vibration unit 255.

The detection unit 37 can have a configuration for acquiring various kinds of information to recognize at least one of a state of the information processing device 30, an external environment of the information processing device 30, and a state of a user using the information processing device 30.

The device information storage unit 39 is a storage unit that stores device information regarding the information processing device 30. In addition, device information regarding the information processing device 30 including the device information storage unit 39 may be stored in advance in the device information storage unit 39.

The communication control unit 331 is a control unit that controls an operation of the communication unit 31. The communication control unit 331 performs a predetermined communication protocol with the external information processing device 10 connected via the network N1 to establish communication with the external information processing device 10.

The cooperation processing unit 333 mainly operates on the basis of an instruction from the external information processing device 10 (for example, the information processing device 10 operating as a master).

Specifically, the cooperation processing unit 333 transmits the device information stored in the device information storage unit 39 to the information processing device 10 in accordance with an instruction from the external information processing device 10.

Also, the cooperation processing unit 333 may transmit information acquired by the detection unit 37 to the information processing device 10 in accordance with an instruction from the external information processing device 10.

The notification control unit 335 is configured to control an operation related to information notification. When an instruction related to the information notification is received from the external information processing device 10, the notification control unit 335 acquires notification target information from the information processing device 10 and causes the notification unit 35 to notify the information on the basis of the notification method notified of together.

The example of the functional configuration of the information processing device 10 has been described above with reference to FIGS. 4 to 9 particularly focusing on the information processing device 10 which forms the cooperation network 2 in the information processing system 1 according to the embodiment.

In addition, the functional configuration of the information processing device 10 described above is merely an example and the present disclosure is not necessarily limited to the above-described configuration. For example, of the control units 23 and 33, a part of the configuration may be provided outside of the information processing device 10 (for example, the cooperation server 5). As a specific example, by providing the analysis unit 237 for the cooperation server 5, the process according to the recognition of various states may be performed by the cooperation server 5 to reduce a process load of each information processing device 10. Also, it is needless to say that the configurations (for example, the control units 23 and 33) performing various processes of the information processing device 10 can be configured by electronic circuits that perform various calculation processes.

### 3. Processes

Next, an example of the flow of a series of operations of the information processing device 10 will be described particularly focusing on the information processing device 10 which forms the cooperation network 2 in the information processing system 1 according to the embodiment. In addition, in this description, the flow of the series of operations of the information processing device 10 will be described by dividing the flow into a case in which the information processing device 10 operates as a hardware master and a case in which the information processing device 10 operates as a software master.

### 3.1. When Information Processing Device Operates as Hardware Master

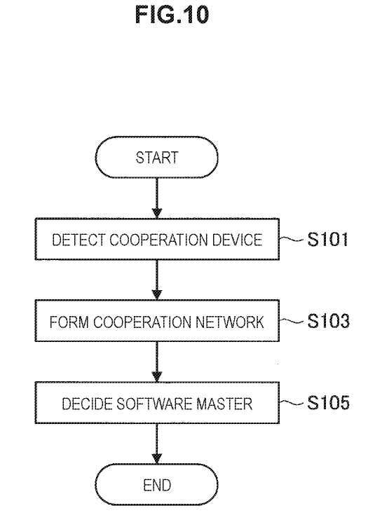

First, an example of the flow of a series of operations of the information processing device 10 when the information processing device 10 operates as a hardware master will be described with reference to FIG. 10. FIG. 10 is a flowchart illustrating an example of the flow of a series of operations of the information processing device 10 according to the embodiment and illustrates an example of a case in which the information processing device 10 operates as the hardware master. In addition, the description will be made assuming that the “ information processing device 10 a” operates as a hardware master among the information processing devices 10 that form the cooperation network 2 to distinguish the information processing device 10 operating as the hardware master and the external information processing device 10 from each other.

### (Steps S101 and S103)

The information processing device 10a which can operate as the hardware master first operates as the hardware master and establishes communication with the external information processing device 10 via the network Ni. As a specific example, when a user manipulation of forming the cooperation network 2 (establishing communication between the information processing devices 10) is received, the information processing device 10a starts an operation as the hardware master using the user manipulation as a trigger.

At this time, when there is the external information processing device 10 within a communication range of the information processing device 10a, the communication control unit 231 of the information processing device 10a establishes communication by transmitting a connection request to the external information processing device 10 and performing a predetermined communication protocol. Also, the communication control unit 231 of the information processing device 10a may establish communication by receiving the connection request from the external information processing device 10 and performing the predetermined communication protocol with the external information processing device 10.

In this way, the information processing device 10a detects the external information processing device 10 (that is, a cooperation device) which is within the communication range (step S101) and forms the cooperation network 2 by establishing communication with the external information processing device 10 (step S103).

In addition, when the communication is established with the external information processing device 10, the cooperation processing unit 233 of the information processing device 10a causes the external information processing device 10 to operate as a slave.

Also, when the cooperation network 2 is formed, the cooperation processing unit 233 of the information processing device 10a acquires the device information regarding the external information processing device 10 from the external information processing device 10 and generates the profile table on the basis of the acquired device information. Also, at this time, of the external information processing devices 10, the information processing device 10 which can operate as the hardware master or the software master may acquire the device information from the other information processing devices 10 and generate the profile table as in the information processing device 10a.

### (Step S105)

Subsequently, on the basis of the generated profile table, the cooperation processing unit 233 of the information processing device 10a specifies the information processing device 10 operating as the software master among the information processing devices 10 which form the cooperation network 2, including the information processing device 10a.

Specifically, when there is the information processing device 10 with the higher attribute or specification (for example, performance) than the information processing device 10 a among the external information processing devices 10 on the basis of the profile table, the cooperation processing unit 233 causes the information processing device 10 to operate as the software master. As a specific example, when there is the information processing device 10 with higher priority than the information processing device 10a among the external information processing devices 10 on the basis of the prioritization illustrated in FIG. 6, the information processing device 10 operates as the software master. In addition, in this case, the cooperation processing unit 233 causes the information processing device 10a to operate as the slave.

Also, when there is no information processing device 10 with the higher attribute or specification (for example, performance) than the information processing device 10a among the external information processing devices 10, the cooperation processing unit 233 causes the information processing device 10a to operate as the software master.

In this way, after the information processing device 10 operating as the software master on the basis of the profile table is designated, the information processing device 10 designated as the software master operates as an actual master.

### [3.2. When Information Processing Device Operates as Software Master]

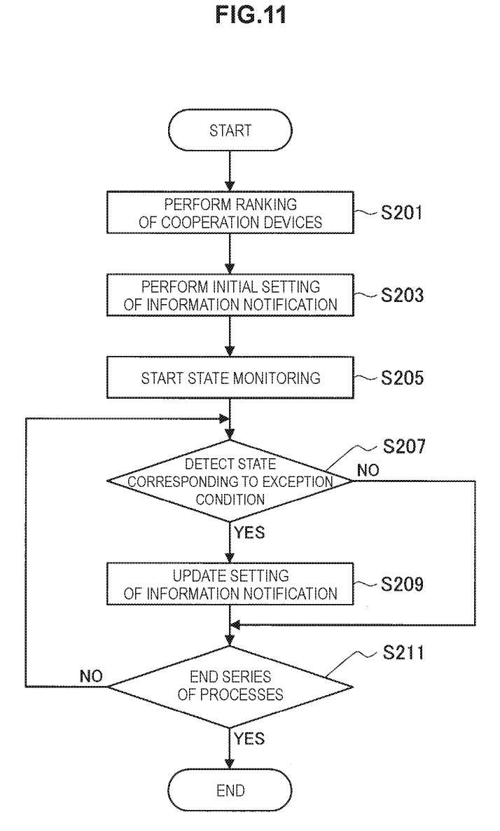

Next, an example of the flow of a series of operations of the information processing device 10 when the information processing device 10 operates as a software master will be described with reference to FIG. 11. FIG. 11 is a flowchart illustrating an example of the flow of a series of operations of the information processing device 10 according to the embodiment and illustrates an example of a case in which the information processing device 10 operates as a software master. In addition, the description will be made assuming that the “information processing device 10 a” operates as a software master among the information processing devices 10 that form the cooperation network 2 to distinguish the information processing device 10 operating as the software master and the external information processing device 10 from each other.

### (Step S201)

The cooperation processing unit 233 of the information processing device 10a operating as the software master first calculates the performance value Spec of each of the information processing devices 10 which form the cooperation network 2 for each item of the performance information in regard to each of the functions for the information notification.

For example, when the “Visual” function is focused on, the cooperation processing unit 233 calculates the performance value Spec of each information processing device 10 for each item of the performance information set in advance in regard to the “Visual” function. For example, as the items of the performance information corresponding to the “Visual” function, a “screen size,” a “resolution,” the “number of colors,” and “frequency” can be exemplified. In addition, the performance value Spec is calculated on the basis of the above-described (Equation 1).

Subsequently, the cooperation processing unit 233 performs ranking between the information processing devices 10 which form the cooperation network 2 for each item of the performance information on the basis of the performance value Spec of each information processing device 10 calculated for the item (that is, sets ranks).

Then, the cooperation processing unit 233 calculates a device rank of each information processing device 10 between the information processing devices 10 which form the cooperation network 2 on the basis of the ranking of each item of the performance information. In addition, the device rank of each information processing device 10 is calculated on the basis of the above-described (Equation 2).

As a specific example, when the device rank corresponding to the “Visual” function is calculated, the cooperation processing unit 233 calculates the performance values Spec (that is, Spec1 to Spec4) of four items (that is, N=4), the “screen size,” the “resolution,” the “number of colors,” and the “frequency.” Then, the cooperation processing unit 233 calculates the device rank corresponding to the “Visual” function of the information processing device 10 by performing the ranking between the information processing devices 10 for each item of the performance information on the basis of the calculated Spec1 to Spec4 and inputting a result of the ranking into (Equation 2) for each information processing device 10.

In this way, the cooperation processing unit 233 calculates the device rank of each of the information processing devices 10 which form the cooperation network 2 in regard to each function for the information notification. In addition, when the profile table is not generated at the time of calculating the performance value Spec or the device rank, the cooperation processing unit 233 may acquire the device information from the external information processing device 10 and generate the profile table on the basis of the acquired device information.

### (Step S203)

The cooperation processing unit 233 sets the priority between the information processing devices 10 on the basis of the device rank calculated for each of the information processing devices 10 which form the cooperation network 2 in regard of each function for the information notification. Then, the cooperation processing unit 233 decides the information processing device 10 performing each function on the basis of the set priority in regard to each function for the information notification. In this way, the default notification setting is completed.

### (Step S205)

When the default notification setting is completed, the cooperation processing unit 233 starts acquiring information regarding a user and monitors various states on the basis of the information.

For example, the cooperation processing unit 233 acquires information indicating various states such as the state of the cooperation network 2 used by the user or the information processing devices 10 which form the cooperation network 2, the external environment of the cooperation network 2, and the state of the user from the analysis unit 237.

Also, the cooperation processing unit 233 may acquire information regarding the user from information of which the user is notified (for example, notification target information such as a mail).

### (Steps S207 and S209)

Then, when a state corresponding to a pre-decided exception condition is detected on the basis of the acquired information regarding the user (YES in step S207), the cooperation processing unit 233 updates the notification setting in accordance with the detected state as an exception process (step S209).

For example, the cooperation processing unit 233 is assumed to detect a state in which the user is “reading an electronic book” while being moving, as shown in “No. 5” of FIG. 9. In this case, the cooperation processing unit 233 updates the notification setting so that the notification of information serving as audio information is suppressed and notification of information serving as video information is output at a position such as the vicinity of an end portion at which there is no interference on a screen on which an execution result of an application of the “electronic book” is output.

### (Step S207)

Also, it is needless to say that the cooperation processing unit 233 retains the existing notification setting as long as the state corresponding to the exception condition is not detected (NO in step S207).

### (Step S211)

As described above, until an instruction to end the series of processes is given, the cooperation processing unit 233 of the information processing device 10a continues monitoring of the various states based on the information regarding the user and the updating of the notification setting adapted to the detected states (in particular, the states corresponding to the exception conditions) (NO in step S211). Then, when an instruction related to ending of a cooperation process or ending of a process of turning off power is received (YES in step S211), the cooperation processing unit 233 ends the above-described series of processes.

The example of the flow of the series of operations of the information processing device 10 has been described above with reference to FIGS. 10 and 11 particularly focusing on the information processing device 10 which forms the cooperation network 2 in the information processing system 1 according to the embodiment.

### 4. EXAMPLES

Next, particularly specific examples of the operations of the information processing devices 10 which form the cooperation network 2 will be described as examples of the information processing system 1 according to the embodiment.

### 4.1. Example 1

### Control Example When Software Master Withdraws

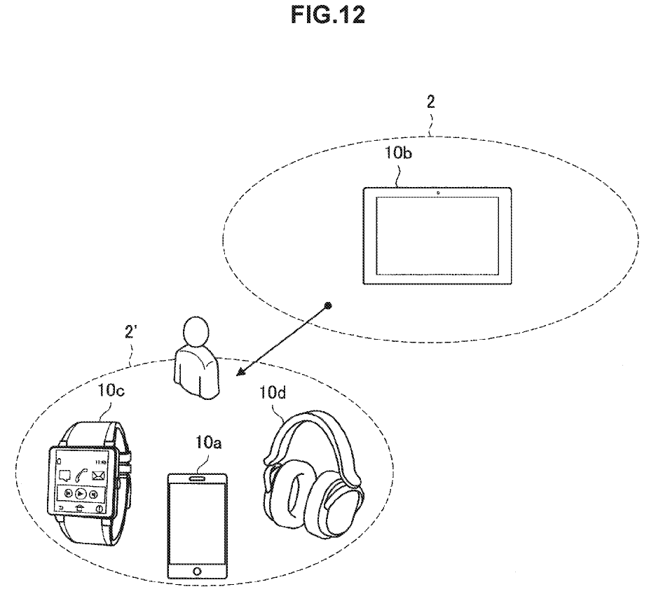

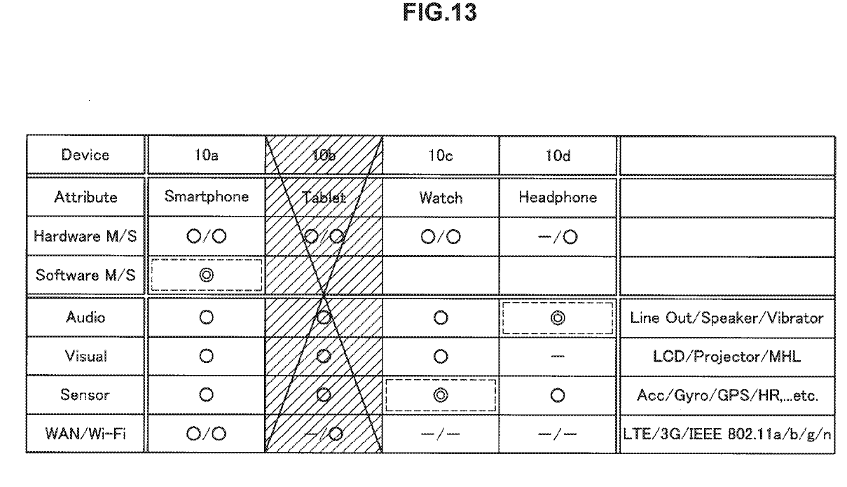

First, an example of control of the cooperation network 2 when the information processing device 10 operating as a software master withdraws from the cooperation network 2 will be described as Example 1 with reference to FIGS. 12 and 13. FIGS. 12 and 13 are explanatory diagrams illustrating an example of control of the cooperation network 2 according to Example 1.

For example, FIG. 12 illustrates a state in which a user carrying the information processing devices 10a, 10c, and 10d withdraws from a range N10b in which the information processing device 10b can perform communication from a state in which the information processing devices 10a to 10d form the cooperation network 2. That is, the example illustrated in FIG. 12 is an example of a case in which the information processing device 10b withdraws from the cooperation network 2 and the information processing devices 10a, 10c, and 10d form the cooperation network 2 and operate in cooperation with one another.

Here, when the information processing device 10b operates as a software master before withdrawal from the cooperation network 2, a state in which there is no software master in the cooperation network 2 after the withdrawal is realized. In this case, the information processing device 10 which can operate as the software master among the information processing devices 10a, 10c, and 10d operates as a new software master.

For example, FIG. 13 is an explanatory diagram illustrating an example of control of the cooperation network 2 when the information processing device 10b withdraws from the cooperation network 2. As an example of a specific use scene illustrated in FIG. 13, a case in which a user carrying the information processing devices 10a, 10c, and 10d among the information processing devices 10a to 10d temporarily stops using the information processing device 10b (the tablet terminal) to perform running can be exemplified.

As illustrated in FIG. 13, it is assumed that the information processing device 10b (the tablet terminal) operating as the software master among the information processing devices 10a to 10d which form the cooperation network 2 withdraws from the cooperation network 2. In addition, in the example illustrated in FIG. 13, description will be made assuming that the information processing device 10a (the smartphone) and the information processing device 10c (the watch) among the information processing devices 10a, 10c, and 10d can operate as software masters.

When at least one of the information processing devices 10a and 10c detects that the communication with the information processing device 10b operating as the software master is disconnected, the information processing device 10b is recognized to withdraw from the cooperation network 2. Here, the information processing device 10a is assumed to detect that the information processing device 10b withdraws from the cooperation network 2. In addition, for example, when polling is performed on the information processing device 10b at a predetermined timing and there is no response from the information processing device 10b, the information processing device 10a may recognize that the information processing device 10b withdraws from the cooperation network 2. Of course, the method is not limited as long as the information processing device 10a can detect that the information processing device 10b withdraws from the cooperation network 2.

When the session of the information processing device 10b from the cooperation network 2 is detected, the information processing device 10a specifies a new software master among the information processing devices 10 which form the cooperation network 2 after the information processing device 10b withdraws. For example, in the example illustrated in FIG. 13, the information processing device 10a (the smartphone) is set as a new software master instead of the withdrawal information processing device 10b (the tablet terminal).

In addition, the method of deciding a new software master is the same as that of the case in which the information processing device 10 operates as a hardware master. That is, the information processing device 10a may cause the information processing device 10 with a higher attribute or specification (for example, performance) among the information processing devices 10a, 10c, and 10d which form the cooperation network 2 to operate as a software master on the basis of the profile table. Also, the information processing device 10a may generate a new profile table when the profile table is not retained.

When the new software master is set, the subsequent operations are the same as those of the case of the cooperation network 2 according to the above-described embodiment. That is, the information processing device 10 set as the software master calculates the device rank of each information processing device 10 for each function related to the information notification on the basis of the profile table and performs the default notification setting on the basis of the calculated device rank of each information processing device 10.

When the default notification setting is completed, the information processing device 10a operating as the new software master acquires the information regarding the user and appropriately updates the notification setting in accordance with the acquired information regarding the user.

For example, the information processing device 10a is assumed to recognize that the user is “running” from a detection result of an acceleration sensor mounted on the information processing device 10c (the watch) and the fact that an application of “coaching” is being executed. In this case, the information processing device 10a may update the notification setting on the basis of the exception process associated in advance with the exception condition indicating the case in which the user is “running.”

Specifically, during the running, there is a tendency that it is difficult for the user tends to refer to display information (for example, video information displayed on a display). Therefore, in this case, the information processing device 10a may notify of information, for example, by preferring the “Audio” function to the “Visual” function. In addition, at this time, the information processing device 10a may suppress the information notification by the “Visual” function. In the example illustrated in FIG. 13, the information processing device 10a suppresses the information notification by the “Visual” function and allocates the “Audio” function to the information processing device 10d (the headset).

Also, the information processing device 10a allocates the information processing device 10c (the watch) which has the “Sensor” function (for example, “heart rate detection (HR: Heart Rate)”) corresponding to the application of “coaching” which is being executed to the “Sensor” function among the information processing devices 10 which has the “Sensor” function

The example of the control when the information processing device 10 operating as the software master withdraws from the cooperation network 2 has been described above as Example 1 with reference to FIGS. 12 and 13.

As described above, even when the information processing device 10 operating as the software master withdraws, another information processing device 10 is set as a new software master in the cooperation network 2 according to Example 1. In such a configuration, the cooperation network 2 according to Example 1 can continuously operate without being involved in a troublesome manipulation by the user even in a situation in which the configurations of the information processing devices 10 which form the cooperation network 2 are dynamically changed.

In addition, the example of the case in which the information processing device 10 withdraws from the cooperation network 2 has been described above. However, a software master is newly set even when the information processing device 10 newly participates in the cooperation network 2. In this case, when the information processing device 10 operating as the software master detects that the new information processing device 10 participates in the cooperation network 2, the software master may be set again. Specifically, the information processing device 10 operating as the software master may cause another information processing device 10 to operate as a new software master when the other information processing device 10 newly participating in the cooperation network 2 has a higher attribute or specification than the self- information processing device 10.

### 4.2. Example 2

### Control Example when Image is Photographed

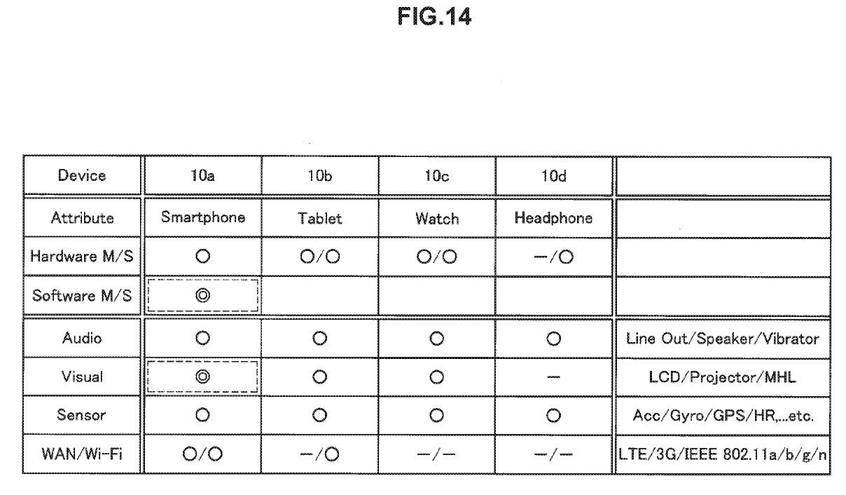

Next, an example of control of the cooperation network 2 when the information processing device 10 including an imaging unit photographs an image among the information processing devices 10 which form the cooperation network 2 will be described as Example 2 with reference to FIG. 14. FIG. 14 is an explanatory diagram illustrating an example of control of the cooperation network 2 according to Example

For example, in the example illustrated in FIG. 14, when a user manipulates the information processing device 10a (the smartphone) among the information processing devices 10a to 10d which form the cooperation network 2, the imaging unit contained in the information processing device 10a is assumed to start photographing an image.

In this case, for example, of the information processing devices 10 which form the cooperation network 2, the information processing device 10 operating as a software master causes the manipulation target information processing device 10a to operate as the software master and the self-information processing device operates as a slave.

Also, for example, the information processing device 10a set as a new software master is assumed to recognize that the user “stops” on the basis of a detection result of an acceleration sensor of one information processing device 10. Subsequently, the information processing device 10a recognizes that the user is “photographing a still image” since a “camera (still image photographing)” application is being executed. Then, the information processing device 10a updates the notification setting on the basis of an exception process associated in advance with an exception condition indicating a case in which the user is “photographing a still image.”

Specifically, the information processing device 10a allocates notification by audio information from the “camera (still image photographing)” application to the self-information processing device (the information processing device 10 a) and suppresses other notification such as notification by audio information (that is, information notification by the “Audio” function). Also, the information processing device 10a causes the display unit 251 (for example, a display) of the self-information processing device to output a video output (for example, playback) from the “camera (still image photographing)” application by allocating notification by video information (that is, the “Visual” function) to the self-information processing device (the information processing device 10a).

Also, in the example illustrated in FIG. 14, the information processing device 10 a executing the “camera (still image photographing)” application can use WAN and Wi-Fi as “network functions.” In this case, the information processing device 10a may access a predetermined network service (cloud) by using WAN or Wi-Fi and uploads a photographed image to the network service. In addition, at this time, the information processing device 10 a may preferentially use any one of WAN and Wi-Fi and may use the other of WAN and Wi-Fi when it is difficult to use the one.

The example of the control of the cooperation network 2 when the information processing device 10 including the imaging unit photographs an image among the information processing devices 10 which form the cooperation network 2 has been described above as Example 2 with reference to FIG. 14.

### 4.3. Example 3

### Control Example when User is Moving By Train

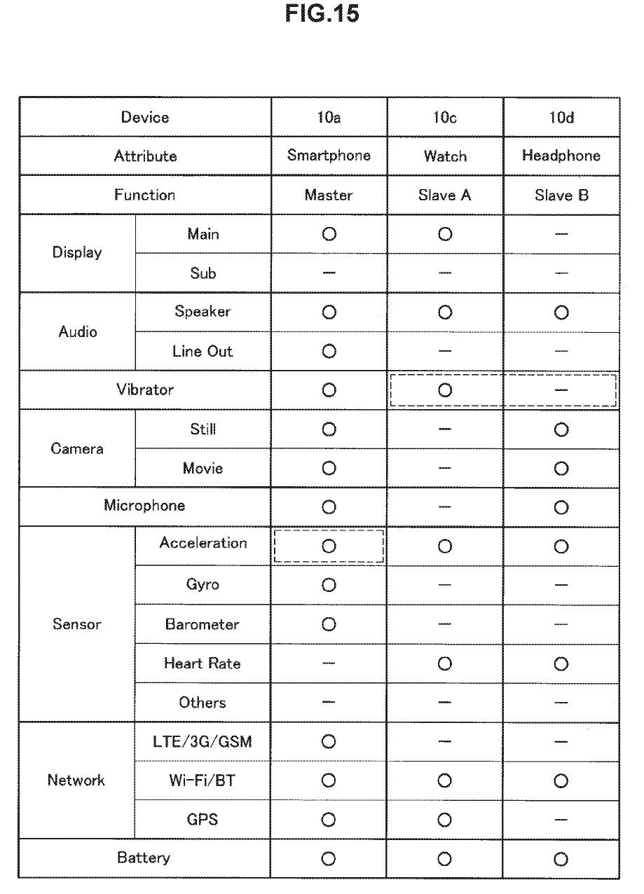

Next, an example of a case in which a function related to information notification is controlled more finely will be described as Example 3. An example of control of the cooperation network 2 when it is recognized that a user using the cooperation network 2 is moving by train will be described as Example 3 with reference to FIG. 15. FIG. 15 is an explanatory diagram illustrating an example of control of the cooperation network 2 according to Example 3.

The example illustrated in FIG. 15 is an example in which the information processing device 10a (the smartphone), the information processing device 10c (the watch), the information processing device 10d (the headset) form the cooperation network 2 and operate in cooperation with one another. In addition, in the example illustrated in FIG. 15, the information processing device 10a operates as a software master and the information processing devices 10c and 10d operate as slaves.

Also, in the example illustrated in FIG. 15, the information processing device 10 a operating as the software master allocates a function related to acceleration detection to the information processing device 10a on the basis of, for example, performance information (in other words, device information) of an acceleration sensor provided in each of the information processing devices 10a, 10c, and 10d.

First, the information processing device 10a operating as the software master recognizes a behavior or an external environment of the user using the cooperation network 2 on the basis of various kinds of information detected by the detection unit 27 or the information processing devices 10c and 10d.

As a specific example, the information processing device 10a recognizes that the position of the user is “moving” on the basis of a detection result of GPS or the like and recognizes “stopping” of the user as mono on the basis of the detection result of the acceleration sensor. In this case, the information processing device 10a can recognize that the user is moving by transportation means such as a vehicle or a train.

Also, at this time, the information processing device 10a may recognize a movement path from a history of a change in the position of the user and recognize the transportation means used for the user to move from the recognized movement path. For example, when the recognized movement path is identical to a roadway, the information processing device 10a can recognize that the user is moving by train.

In this way, the information processing device 10a is assumed to recognize that the user is moving by train.

Also, the information processing device 10a recognizes each application which is being used by the user on the basis of a use ratio of the application. Here, the information processing device 10a is assumed to detect that an “audio” application is being executed and recognize that the user is “listening to music” by the “audio” application from the detection result.

Also, at this time, the information processing device 10a may detects that the information processing devices 10c and 10d configured as wearable devices are worn and recognize that the information processing devices 10c and 10d are being used by the user.

Subsequently, the information processing device 10a updates the notification setting on the basis of the recognized state. For example, since the information processing device 10 a recognizes that the information processing devices 10c and 10d configured as the wearable devices are being used by the user, the information processing device 10a preferentially selects the information processing devices 10c and 10d as information notification destinations.

Also, since the information processing device 10a recognizes that the user is “listening to music,” the information processing device 10a excludes the headset (the information processing device 10d) from allocation targets to functions for information notification.

From the foregoing recognition result, the information processing device 10a may select the information processing device 10c (the watch) as an information notification destination, as illustrated in FIG. 15.

Subsequently, the information processing device 10a controls the information notification method. As a specific example, on the basis of previous user setting, the information processing device 10a selects whether notification target information is notified of by one of video information (the “Visual” function), audio information (the “Audio” function), and vibration information (the “Vibrator” function).

Also, as another example, since the information processing device 10a recognizes that the user is “moving by train,” the information processing device 10a may suppress the information notification (that is, the “Audio” function) by the audio information and select the information notification (the “Vibrator” function) by the vibration information.

On the basis of the foregoing recognition result, the information processing device 10 a updates the notification setting. Thus, the setting is updated so that the user is notified of information in a preferred mode in which the notification setting of the cooperation network 2 is adapted to recognition results of various states, that is, the fact that the user is “moving by train” and is “listening to music.”

The example of the control of the cooperation network 2 when it is recognized that the user using the cooperation network 2 is moving by train has been described above as Example 3 with reference to FIG. 15.

### 4.4. Example 4

### Control Example Related to Allocation of Functions Involved in Detection of Information

In the foregoing embodiment and examples, the description has been made mainly focusing on the control when the functions related to the information notification are allocated to one of the information processing devices 10 which form the cooperation network 2. On the other hand, the function controlled to be allocated to each information processing device 10 is not necessarily limited to the function related to the information notification.

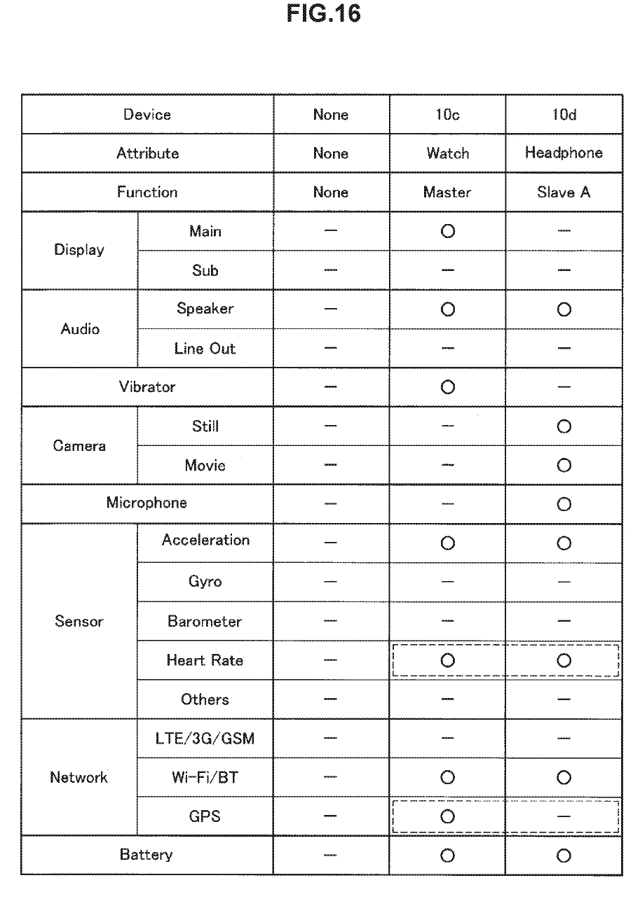

Accordingly, in Example 4, an example of control when a function related to detection of various kinds of information is allocated to at least one of the information processing devices 10 which form the cooperation network 2 will be described with reference to FIG. 16 by exemplifying a case in which it is recognized that the user is running. FIG. 16 is an explanatory diagram illustrating an example of control of the cooperation network 2 according to Example 4.

The example illustrated in FIG. 16 is an example in which the information processing device 10c (the watch) and the information processing device 10d (the headset) form the cooperation network 2 and operate in cooperation with each other. In addition, in the example illustrated in FIG. 16, the information processing device 10c operates as a software master and the information processing device 10d operates as a slave.

First, the information processing device 10c operating as the software master recognizes a behavior or an external environment of the user using the cooperation network 2 on the basis of various kinds of information detected by the detection unit 27 or the information processing device 10d.

As a specific example, the information processing device 10c recognizes that the user is “moving” along an “outdoor running course” on the basis of a detection result of GPS or the like and recognizes that the user is “running” along with a detection result of the acceleration sensor. Also, at this time, the information processing device 10c is assumed to detect that a “coaching” application is being executed on the basis of a use ratio of each application.

In this case, the information processing device 10c specifies the information processing device 10 which has the “Sensor” function and corresponds to the “coaching” application which is being executed and allocates the “Sensor” function to the specified information processing device 10.

For example, the “coaching” application is assumed to correspond to a “heart rate detection (HR)” function of detecting a heart rate of the user.

In this case, the information processing device 10c specifies the information processing devices 10c and 10d which has the “heart rate detection (HR)” function on the basis of the profile table illustrated in FIG. 16 and generated in advance and allocates the “heart rate detection (HR)” function to at least one of the specified information processing devices 10c and 10d.

Also, at this time, the information processing device 10c may prefer, for example, the information processing device 10d operating as the slave between the information processing devices 10c and 10d and allocate the “heart rate detection (HR)” function to the information processing device 10d. Also, as another example, the information processing device 10c may prefer the information processing device 10 with higher heart rate detection performance between the information processing devices 10c and 10d and allocate the “heart rate detection (HR)” function to the information processing device 10.

Also, the “coaching” application corresponds to a GPS function and is assumed to have a function of recording a running course of the user on the basis of positional information detected by the GPS function. In this case, the information processing device 10c specifies the information processing device 10c which has the GPS function on the basis of the profile table generated in advance and allocates the specified information processing device 10c to the GPS function.

Through the foregoing control, the notification setting is updated so that various kinds of information are detected in a preferred mode in which the setting related to the detection of each piece of information of the cooperation network 2 is adapted to recognition results of various states, that is, the fact that the user is “running” using the “coaching” application.

The example of the control when the function related to the detection of the various kinds of information is allocated to at least one of the information processing devices 10 which form the cooperation network 2 has been described above as Example 4 with reference to FIG. 16 by exemplifying a case in which it is recognized that the user is running.

### 4.5. Example 5

### Control Example Related to Allocation of Functions Involved in Image Photographing

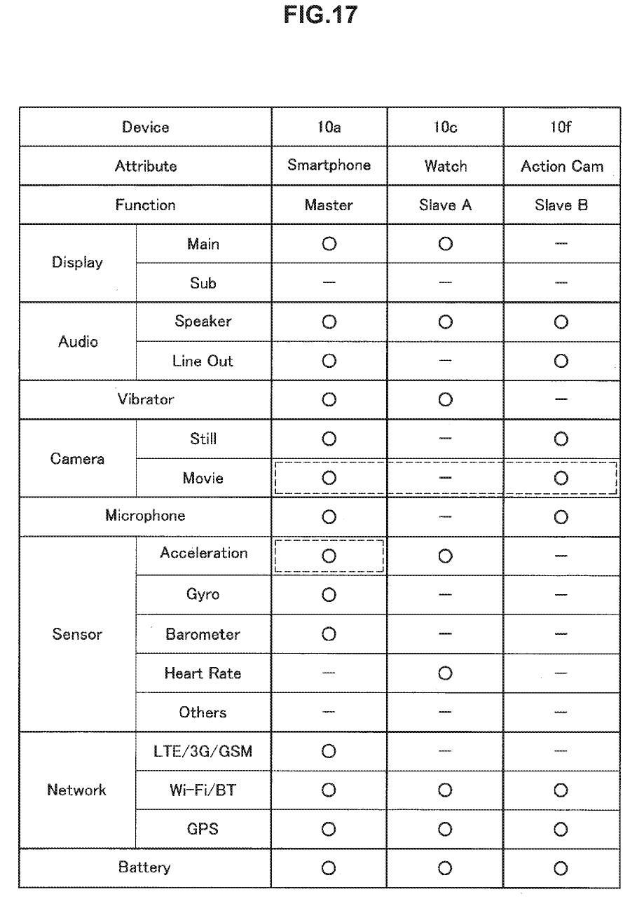

Next, in Example 5, an example of control when a function related to image photographing is allocated to at least one of the information processing devices 10 which form the cooperation network 2 will be described with reference to FIG. 17 exemplifying a case in which it is recognized that a user photographs a moving image while moving. Specifically, in Example 5, an example of a case in which the function related to the image photographing is allocated to at least one of the information processing devices 10 which form the cooperation network 2 when it is recognized that the user using the cooperation network 2 photographs a moving image while moving will be described. FIG. 17 is an explanatory diagram illustrating an example of control of the cooperation network 2 according to Example 5.

The example illustrated in FIG. 17 is an example in which the information processing device 10a (the smartphone), the information processing device 10c (the watch), and an information processing device 10f (a digital video camera) form the cooperation network 2 and operate in cooperation with one another. In addition, in the example illustrated in FIG. 17, the information processing device 10a operates as a software master and the information processing devices 10c and 10f operate as slaves. Also, in the description, a digital video camera such as a so-called “Action Cam (registered trademark),” which has various functions related to moving image photographing, such as a camera shake correction function, considering of photographing of a moving image during movement is assumed to be used as the information processing device 10f (digital video camera).

First, the information processing device 10a operating as the software master recognizes a behavior or an external environment of the user using the cooperation network 2 on the basis of various kinds of information detected by the detection unit 27 or the information processing device 10d.

As a specific example, the information processing device 10a recognizes that the user is “moving” on the basis of a detection result of GPS or the like or a detection result of an acceleration sensor. Also, at this time, the information processing device 10c is assumed to detect that a “moving image photographing” application is being executed on the basis of a use ratio of each application.

In this case, the information processing device 10a specifies the information processing device 10 which has a “Movie” function of photographing a moving image and corresponding to a “moving image photographing” application which is being executed and allocates the “Movie” function to the specified information processing device 10.

Specifically, the information processing device 10a specifies the information processing devices 10a and 10f which has the “Movie” function on the basis of the profile table illustrated in FIG. 17 and generate in advance and allocates the “Movie” function to at least one of the specified information processing devices 10a and 10f.

In addition, at this time, the information processing device 10a may prefer the information processing device 10f operating as the slave between the information processing devices 10a and 10f and allocates the “Movie” function to the information processing device 10f.

Also, as another example, the information processing device 10a may allocate the “Movie” function to the information processing device 10f (including, for example, a camera shake correction function) more suitable for “moving image photographing” during “moving” on the basis of performance information regarding the “Movie” function of each of the information processing devices 10a and 10f.

In addition, when the information processing device 10 for the moving image photographing is selected by the user, it is needless to say that the information processing device 10a may allocate the “Movie” function to the selected information processing device 10.

Through the foregoing control, the setting is updated so that a moving image is photographed in the preferred mode in which the setting related to the image photographing is adapted to recognition results of various states, that is, the fact that the user “photographs a moving image” while “moving.”

The example of the control when the function related to the image photographing is allocated to at least one of the information processing devices 10 which form the cooperation network 2 has been described as Example 5 with reference to FIG. 17 exemplifying the case in which it is recognized that the user photographs a moving image while moving.

### 5. HARDWARE CONFIGURATION

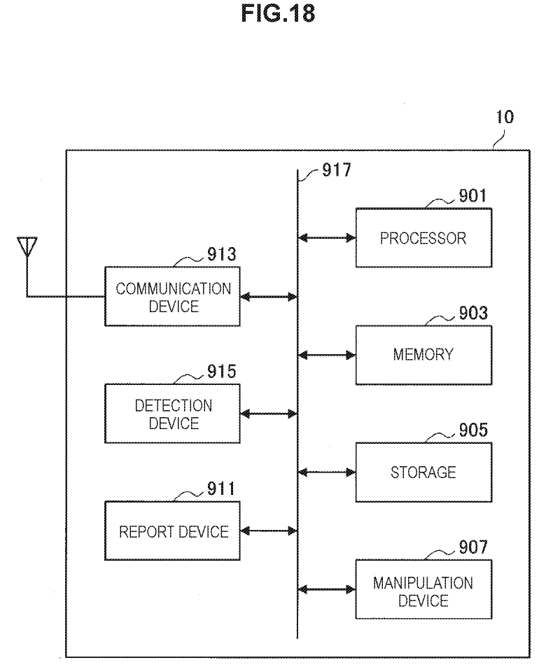

Next, an example of a hardware configuration of the information processing device 10 according to each embodiment of the present disclosure will be described with reference to FIG. 18. FIG. 18 is a diagram illustrating an example of the hardware configuration of the information processing device 10 according to an embodiment of the present disclosure.

As shown in FIG. 18, the information processing device 10 according to the present embodiment includes a processor 901, a memory 903, a storage 905, a manipulation device 907, a report device 911, a communication device 913, a detection device 915 and a bus 917.

The processor 901 may be a central processing unit (CPU), a graphics processing unit (GPU), a digital signal processor (DSP) or a system on chip (SoC), for example, and performs various processes of the information processing device 10. For example, the processor 901 may be configured as an electronic circuit for performing various arithmetic processes. Further, the configuration of the aforementioned control units 23 and 33 may be realized by the processor 901.

The memory 903 includes a random access memory (RAM) and a read only memory (ROM) and stores programs executed by the processor 901 and data. The storage 905 may include a storage medium such as a semiconductor memory or a hard disk. For example, the above-described device information storage units 29 and 39 can be realized by at least one of the memory 903 and the storage 905 or a combination of both the memory 903 and the storage 905.

The manipulation device 907 has a function of generating an input signal for performing a desired manipulation of a user. The manipulation device 907 may be configured as a touch panel, for example. As another example, the manipulation device 907 may be composed of an input unit through which the user inputs information, for example, a button, a switch and the like, an input control circuit that generates an input signal based on input from the user and provides the input signal to the processor 901 and the like.

The report device 911 is an example of an output device and may be a device such as a liquid crystal display (LCD) device or an organic light emitting diode (OLED) display. In this case, the report device 911 may report predetermined information to the user by displaying a screen. In addition, the aforementioned display unit 251 may be realized by the report device 911.

Also, the report device 911 may be a device such as a speaker that reports predetermined information to a user by outputting a predetermined audio signal. In addition, the above-described audio output unit 253 can be realized by the report device 911.

Also, the report device 911 may be a device such as a so-called vibrator that vibrates to report predetermined information to a user. In addition, the above-described vibration unit 255 can be realized by the report device 911.

Also, the example of the report device 911 described above is merely an example. The mode of the report device 911 is not particularly limited as long as predetermined information is reported to a user. As a specific example, the report device 911 may be a device such as a light emitting diode (LED) that reports predetermined information to the user by a lighting or blinking pattern.

The communication device 913 is a communication means included in the information processing device 10 and communicates with an external device through a network. The communication device 913 is a wired or wireless communication interface. When the communication device 913 is configured as a wireless communication interface, the communication device 913 may include a communication antenna, a radio frequency (RF) circuit, a baseband processor and the like.

The communication device 913 has a function of performing various signal processes on a signal from an external device and may provide a digital signal generated from a received analog signal to the processor 901. In addition, the aforementioned communication units 21 and 31 may be realized by the communication device 913.

The detection device 915 is a device for detecting variations in the position and orientation of the housing of the information processing device 10. For example, the detection device 915 may be composed of various sensors such as an acceleration sensor, an angular velocity sensor, etc. In addition, the aforementioned report devices 27 and 37 may be realized by the detection device 915.

The bus 917 connects the processor 901, the memory 903, the storage 905, the manipulation device 907, the display device 909, the communication device 913 and the detection device 915 to one another. The bus 917 may include a plurality of types of buses.

Furthermore, a program for causing hardware such as a processor, a memory and a storage included in a computer to execute the same functions as components of the aforementioned information processing device 10 may be created. In addition, a computer readable recording medium storing the program may be provided.

### 6. CONCLUSION

As described above, in the information processing system 1 according to the embodiment, the information processing device 10 operating as a master on the basis of the device information regarding the information processing devices 10 which form the cooperation network 2 is decided. Then, the information processing device 10 operating as the master decides the information processing device 10 to which each function related to the information notification is allocated on the basis of the device information regarding each information processing device 10 among the information processing devices 10 which form the cooperation network 2 (that is, performs the default notification setting).

Also, the information processing device 10 operating as the master acquires information regarding a user from each of the information processing devices 10 which form the cooperation network 2 and recognizes various states (for example, user states or external environments) on the basis of the acquired information. Then, in accordance with the recognized states, the information processing device 10 operating as the master updates the notification setting on the basis of an exception process associated in advance with the states.

In the foregoing configuration, in the information processing system 1 according to the embodiment, the information processing device 10 notifying of information or the information notification method are dynamically switched without performing a user manipulation in accordance with a use situation of the cooperation network 2 (for example, a user state or an external environment).

Also, even when the information processing device 10 operating as the master withdraws from the cooperation network 2, another information processing device 10 which can operate as the master operates as a new master in the cooperation network 2 according to the embodiment.

In such a configuration, in the information processing system 1 according to the embodiment, a cooperation state (for example, setting of the master and the slaves) between the information processing devices 10 can be dynamically updated in accordance with a change a situation under a situation in which the information processing devices 10 which form the cooperation network 2 are sequentially switched.

In this way, in the information processing system 1 according to the embodiment, the user can be notified of information in a preferred mode in accordance with a use situation of the cooperation network 2.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a control unit configured to select a device caused to perform information notification from a plurality of devices each including a notification unit and cooperating via a network on the basis of information regarding the devices; and

an acquisition unit configured to acquire information regarding a user,

in which the control unit selects the device caused to perform the information notification on the basis of the acquired information regarding the user.

(2)

The information processing device according to (1),

in which the information regarding the user includes information indicating a recognized behavior of the user.

(3)

The information processing device according to (1) or (2),

in which the information regarding the user includes information indicating a recognized environment around the user.

(4)

The information processing device according to any one of (1) to (3),

in which at least a part of the information regarding the user includes information regarding information of which the user is notified.

(5)

The information processing device according to (4),

in which the information regarding the information of which the user is notified includes information indicating types of at least some pieces of information included in the information of which the user is notified.

(6)

The information processing device according to (4) or (5b),

in which the information regarding the information of which the user is notified includes information indicating a type of a notification medium of the information of which the user is notified.

(7)

The information processing device according to any one of (4) to (6),

in which the information regarding the information of which the user is notified includes information indicating a transmission source of the information of which the user is notified.

(8)

The information processing device according to any one of (1) to (7),

in which the information regarding the user includes information indicating states of the devices adapted to uses of at least some devices among the plurality of devices.

(9)

The information processing device according to any one of (1) to (8),

in which at least a part of the information regarding the user is generated on the basis of states detected by at least some devices among the information processing device and the plurality of devices.

(10)

The information processing device according to any one of (1) to (9),

in which at least a part of the information regarding the device includes information indicating capability of the notification unit for information notification by the device.

(11)

The information processing device according to (10),

in which the notification unit includes a display unit that displays video information, and

at least a part of the information regarding the device includes information indicating capability related to output of the video information of the display unit.

(12)

The information processing device according to (10) or (11),

in which the notification unit includes an audio output unit that outputs audio information, and

at least a part of the information regarding the device includes information indicating capability related to output of the audio information of the audio output unit.

(13)

The information processing device according to any one of (10) to (12),

in which the notification unit includes a tactile presentation unit that outputs tactile information for presenting a sense of touch or force, and

at least a part of the information regarding the device includes information indicating capability related to output of the tactile information of the tactile presentation unit.

(14)

The information processing device according to any one of (1) to (13),

in which the control unit selects the device caused to perform the information notification in accordance with priority among the devices which is controlled on the basis of the acquired information regarding the user and is based on the information regarding each of the plurality of devices.

(15)

The information processing device according to (14),

in which the control unit

selects an information notification method in accordance with the acquired information regarding the user, and

selects the device caused to perform the information notification by the information notification method in accordance with the priority among the plurality of devices set in regard to the selected information notification method.

(16)

The information processing device according to any one of (1) to (15),

in which the acquisition unit acquires the information regarding the device from each of the plurality of devices, and

the control unit sets priority among the plurality of devices on the basis of the acquired information regarding the device.

(17)

The information processing device according to (16),

in which the control unit ranks, on the basis of performance information of a plurality of items acquired as the information regarding the device, the plurality of devices for each of the items, and sets the priority among the plurality of devices on the basis of the ranks for each of the items.

(18)

The information processing device according to any one of (1) to (17),

in which when the device with higher priority than the information processing device is detected on the basis of the pre-decided priority for deciding a control entity, the control unit transfers control related to selection of the device caused to perform the information notification to the detected device.

(19)

An information processing method including:

selecting, by a processor, a device caused to perform information notification from a plurality of devices each including a notification unit and cooperating via a network on the basis of information regarding the devices; and

acquiring information regarding a user,

in which the device caused to perform the information notification is selected on the basis of the acquired information regarding the user.

(20)

A program causing a computer to perform:

selecting a device caused to perform information notification from a plurality of devices each including a notification unit and cooperating via a network on the basis of information regarding the devices; and

acquiring information regarding a user,

in which the device caused to perform the information notification is selected on the basis of the acquired information regarding the user.

### REFERENCE SIGNS LIST

1 information processing system
2 cooperation network
5 cooperation server
10 information processing device
17 communication unit
20 information processing device
21 communication unit
23 control unit
231 communication control unit
233 cooperation processing unit
235 notification control unit
237 analysis unit
25 notification unit
251 display unit
253 audio output unit
255 vibration unit
27 detection unit
29 device information storage unit
30 information processing device
31 communication unit
33 control unit
331 communication control unit
333 cooperation processing unit
335 notification control unit
35 notification unit
37 detection unit
39 device information storage unit

1. An information processing device comprising:
a control unit configured to select a device caused to perform information notification from a plurality of devices each including a notification unit and cooperating via a network on the basis of information regarding the devices; and
an acquisition unit configured to acquire information regarding a user,
wherein the control unit selects the device caused to perform the information notification on the basis of the acquired information regarding the user.

2. The information processing device according to claim 1,
wherein the information regarding the user includes information indicating a recognized behavior of the user.

3. The information processing device according to claim 1,
wherein the information regarding the user includes information indicating a recognized environment around the user.

4. The information processing device according to claim 1,
wherein at least a part of the information regarding the user includes information regarding information of which the user is notified.

5. The information processing device according to claim 4,
wherein the information regarding the information of which the user is notified includes information indicating types of at least some pieces of information included in the information of which the user is notified.

6. The information processing device according to claim 4,
wherein the information regarding the information of which the user is notified includes information indicating a type of a notification medium of the information of which the user is notified.

7. The information processing device according to claim 4,
wherein the information regarding the information of which the user is notified includes information indicating a transmission source of the information of which the user is notified.

8. The information processing device according to claim 1,
wherein the information regarding the user includes information indicating states of the devices adapted to uses of at least some devices among the plurality of devices.

9. The information processing device according to claim 1,
wherein at least a part of the information regarding the user is generated on the basis of states detected by at least some devices among the information processing device and the plurality of devices.

10. The information processing device according to claim 1,
wherein at least a part of the information regarding the device includes information indicating capability of the notification unit for information notification by the device.

11. The information processing device according to claim 10,
wherein the notification unit includes a display unit that displays video information, and at least a part of the information regarding the device includes information indicating capability related to output of the video information of the display unit.

12. The information processing device according to claim 10,
wherein the notification unit includes an audio output unit that outputs audio information, and
at least a part of the information regarding the device includes information indicating capability related to output of the audio information of the audio output unit.

13. The information processing device according to claim 10,
wherein the notification unit includes a tactile presentation unit that outputs tactile information for presenting a sense of touch or force, and
at least a part of the information regarding the device includes information indicating capability related to output of the tactile information of the tactile presentation unit.

14. The information processing device according to claim 1,
wherein the control unit selects the device caused to perform the information notification in accordance with priority among the devices which is controlled on the basis of the acquired information regarding the user and is based on the information regarding each of the plurality of devices.

15. The information processing device according to claim 14,
wherein the control unit
selects an information notification method in accordance with the acquired information regarding the user, and
selects the device caused to perform the information notification by the information notification method in accordance with the priority among the plurality of devices set in regard to the selected information notification method.

16. The information processing device according to claim 1,
wherein the acquisition unit acquires the information regarding the device from each of the plurality of devices, and
the control unit sets priority among the plurality of devices on the basis of the acquired information regarding the device.

17. The information processing device according to claim 16,
wherein the control unit ranks, on the basis of performance information of a plurality of items acquired as the information regarding the device, the plurality of devices for each of the items, and sets the priority among the plurality of devices on the basis of the ranks for each of the items.

18. The information processing device according to claim 1,
wherein when the device with higher priority than the information processing device is detected on the basis of the pre-decided priority for deciding a control entity, the control unit transfers control related to selection of the device caused to perform the information notification to the detected device.

19. An information processing method comprising:
selecting, by a processor, a device caused to perform information notification from a plurality of devices each including a notification unit and cooperating via a network on the basis of information regarding the devices; and
acquiring information regarding a user,
wherein the device caused to perform the information notification is selected on the basis of the acquired information regarding the user.

20. A program causing a computer to perform:
selecting a device caused to perform information notification from a plurality of devices each including a notification unit and cooperating via a network on the basis of information regarding the devices; and
acquiring information regarding a user,
wherein the device caused to perform the information notification is selected on the basis of the acquired information regarding the user.
